(19) United States
(12) Patent Application Publication
(10) Pub. No.: US 2026/0317075 A1
(43) Pub. Date: Oct. 15, 2026

(54) SMART FEEDING SYSTEM AND METHOD FOR CONTROLLING SAME

(71) Applicant: LS ELECTRIC CO., LTD., Anyang-si, Gyeonggi-do (KR)

(72) Inventor: Ji Woong KIM, Anyang-si, Gyeonggi-do (KR)

(21) Appl. No.: 19/484,928

(22) PCT Filed: Mar. 11, 2024
(86) PCT No.: PCT/KR2024/003115

§ 371 Date: Nov. 17, 2025

(30) Foreign Application Priority Data
Jun. 19, 2023 (KR) 10-2023-0078197
Jun. 19, 2023 (KR) 10-2023-0078198

(51) Int. Cl. B65G 47/14; B65G 27/04; B65G 27/16; B65G 43/08; B65G 47/88

(52) U.S. Cl. CPC B65G 47/14; B65G 27/04; B65G 27/16; B65G 43/08; B65G 47/88

(57) ABSTRACT

A smart feeding system is disclosed. According to an aspect of the present disclosure, the smart feeding system comprises: a component supply unit for receiving a component supplied from the outside; and a component receiving unit positioned below a part of the component supply unit and configured to receive the component transferred from the component supply unit and to provide the received component to the outside.

### CROSS-REFERENCE TO RELATED APPLICATIONS

This application is the National Stage filing under 35 U.S.C. 371 of International Application No. PCT/KR2024/003115, filed on Mar. 11, 2024, which claims the benefit of earlier filing date and right of priority to Korean Application No. 10-2023-0078197, filed on Jun. 19, 2023, and Korean Application No. 10-2023-0078198, filed on Jun. 19, 2023, the contents of which are all hereby incorporated by reference herein in their entirety.

### FIELD

The present disclosure relates to a smart feeding system and a method for controlling the same, and more particularly, to a smart feeding system and a method for controlling the same, which are capable of classifying and supplying a plurality of different components rapidly and accurately through an automated process.

### BACKGROUND

As mass production and automation of products have become common, it has also become common that multiple products are manufactured continuously in a production process, rather than a single product being manufactured in each process.

As one of the approaches for mass production and automation of products, a smart factory may be employed. A smart factory can be utilized to improve work speed and accuracy by minimizing human intervention in processes such as product design, development, and manufacturing. In particular, a smart factory can be used to manufacture industrial products that include various components.

Meanwhile, as the manufacturing industry shifts from the era of low-mix high-volume production to the era of high-mix low-volume production, cases in which a plurality of products manufactured continuously have different specifications are increasing. That is, products belonging to the same product group may be manufactured using components of different specifications, and thus may be used in different environments.

In order to manufacture products having different specifications continuously as described above, a method may be considered in which a plurality of products are grouped according to their specifications, and a group of products having the same specification is manufactured first, followed by the manufacture of another group of products having a different specification. However, in an actual manufacturing environment, it is very difficult to group products that have completely identical specifications.

In addition, even if similar products are successfully grouped, manufacturing all products having the same specification before starting the production of products with different specifications is not desirable in terms of production efficiency.

Accordingly, there is a need for a solution capable of continuously and automatically providing products having different specifications.

Korean Patent Laid-Open Publication No. 10-2023-0058784 discloses a smart factory system of vehicles. Specifically, the publication discloses a smart factory system of vehicles in which components of a vehicle can be supplied by an autonomous mobile robot, with the system being operated based on the autonomous movement of the robot.

However, the smart factory system of vehicles disclosed in the prior art is configured such that a vehicle having a large volume is the final completed product. Accordingly, the production line to which products must be supplied is inevitably large in scale. Therefore, in order to supply components to vehicles moving along the line, an autonomous mobile robot configured to be movable is essentially required.

Japanese Patent Laid-Open Publication No. 2023-029563 discloses a tray component supply device. Specifically, the publication discloses a tray component supply device capable of automatically replacing a magazine that accommodates a plurality of trays.

However, the tray component supply device disclosed in the prior art requires a separate shuttle mechanism for taking out trays. In addition, the prior art also requires a separate structure for lifting and lowering the shuttle mechanism. In other words, the prior art fails to provide a solution for simply structuring the configuration for automatically replacing the magazine.
Korean Patent Laid-Open Publication No. 10-2023-0058784 (2023 May 3.)
Japanese Patent Laid-open Publication No. 2023-029563 (2023 Mar. 3.)

### SUMMARY

The present disclosure is to solve the above problems, and the present disclosure is directed to providing a smart feeding system capable of continuously supplying components and a control method thereof.

The present disclosure is also directed to providing a smart feeding system and a control method thereof that can easily change the components being supplied.

The present disclosure is also directed to providing a smart feeding system and a control method thereof that can simultaneously supply components having different specifications.

The present disclosure is also directed to providing a smart feeding system and a control method thereof that can accurately distinguish a plurality of components.

The present disclosure is also directed to providing a smart feeding system and a control method thereof that can easily and accurately adjust the amount of components being supplied.

The problems of the present disclosure are not limited to those mentioned above, and other problems not mentioned will be clearly understood by those of ordinary skill in the art from the following description.

According to an aspect of the present disclosure, provided is a smart feeding system, comprising: a component supply unit configured to receive components from an external source; and a component receiving unit disposed below at least a portion of the component supply unit and configured to receive the components from the component supply unit and to provide the received components to the outside, wherein the component receiving unit comprises: a receiving conveyor extending in a longitudinal direction and configured to support the components transferred from the component supply unit; and a stopper member configured to divide an inner space of the receiving conveyor into a plurality of spaces along the longitudinal direction, wherein the components transferred from the component supply unit are located in one of the plurality of spaces, the components moved to another one of the plurality of spaces along the longitudinal direction are provided to the outside, and the stopper member is vertically movably coupled to the receiving conveyor so that the one space and the other one space are fluidly connected or blocked.

In this case, a smart feeding system may be provided in which the receiving conveyor includes a vibration belt member configured to be movable to one side and the other side in the longitudinal direction, to support the components, and to surround the inner space from below; and a dividing conveyor partition extending in the longitudinal direction and configured to divide the inner space into a plurality of spaces in a width direction of the vibration belt member.

In addition, a smart feeding system may be provided in which the component supply unit is provided in plurality and the components supplied from some of the plurality of component supply units are delivered to one of the plurality of spaces partitioned by the dividing conveyor partition, and the components supplied from other some component supply units are delivered to another one of the plurality of spaces partitioned by the dividing conveyor partition.

In this case, a smart feeding system may be provided in which the receiving conveyor includes a vibration belt member configured to be movable to one side and the other side in the longitudinal direction, to support the components, and to surround the inner space from below; and a conveyor partition extending in the longitudinal direction and surrounding the inner space in a width direction, and the stopper member is coupled to the conveyor partition.

In addition, a smart feeding system may be provided in which the stopper member is coupled to the conveyor partition, and includes a blocking frame fixedly coupled to the conveyor partition and extending in the width direction; a blocking power device coupled to the blocking frame; and a blocking plate coupled to the blocking power device and configured to divide the inner space into the plurality of spaces, and the blocking power device is configured to support the blocking plate to be vertically movable.

In this case, a smart feeding system may be provided in which the blocking power device is implemented as a pneumatic cylinder including a first portion and a second portion movably coupled to the first portion, wherein the first portion of the blocking power device is coupled to the blocking plate, and the second portion of the blocking power device is coupled to the blocking frame.

In addition, a smart feeding system may be provided in which the stopper member is provided in plurality, and the plurality of stopper members are spaced apart from each other in the longitudinal direction, and the plurality of stopper members are configured to be vertically movable independently of each other.

In this case, a smart feeding system may be provided in which the stopper unit includes a first stopper member positioned at one side in the longitudinal direction, and a second stopper member positioned at the other side in the longitudinal direction.

In addition, a smart feeding system may be provided in which the receiving conveyor includes a blocking partition disposed to face the second stopper member across the first stopper member in the longitudinal direction; a collection space formed between the blocking partition and the first stopper member, the collection space being open at one side in the height direction and configured to accommodate the components to be supplied; and a discharge space formed between the first stopper member and the second stopper member, the discharge space being configured to accommodate the components to be discharged and removed to the outside.

In this case, a smart feeding system may be provided in which the receiving conveyor includes a guide member that extends in the longitudinal direction inside the conveyor partition, with a portion of the guide member positioned in the collection space and the remaining portion positioned in the discharge space, the guide member being configured to guide the components, which are moved from the discharge space to the collection space, toward the inner side in the width direction of the vibration belt member.

In addition, a smart feeding system may be provided in which the smart feeding system further includes a vibration transfer member that is positioned adjacent to the other one space and configured to apply vibration to the components located in the other one space to rearrange the components.

In this case, a smart feeding system may be provided in which the receiving conveyor includes a vibration belt member configured to be movable to one side and the other side in the longitudinal direction, to support the components, and to surround the inner space from below, the vibration transfer member includes a vibration generating device configured to apply the vibration to the vibration belt member; a support plate disposed opposite to the vibration belt member and configured to support the vibration generating device; and an amplifying plate disposed to face the support plate with the vibration generating device interposed therebetween, the amplifying plate being in contact with the vibration belt member and configured to transmit the vibration to the vibration belt member.

In addition, a smart feeding system may be provided in which the vibration transfer member includes an elastic member elastically supporting the amplification plate, the elastic member being coupled to each of the support plate and the amplifying plate.

In this case, a smart feeding system may be provided in which the vibration generating device is implemented as a voice coil motor.

In addition, a smart feeding system may be provided in which the smart feeding system further includes a transfer power device coupled to the vibration belt member and configured to rotate the vibration belt member toward the one side and the other side.

In this case, a smart feeding system may be provided in which the transfer power device is provided as a servo motor.

In addition, a smart feeding system may be provided in which the smart feeding system further includes an input adjusting unit that is positioned, in a height direction, between the component supply unit and the component receiving unit and is configured to receive the components from the component supply unit and deliver the components to the component receiving unit, and the input adjusting unit includes a tray member positioned below the component supply unit and configured to receive the components from the component supply unit; and an input power device coupled to the tray member and configured to movably support a portion of the tray member.

In this case, a smart feeding system may be provided in which the tray member includes a first tray surface positioned adjacent to the component supply unit; a second tray surface disposed to face the component supply unit with the first tray surface interposed therebetween and coupled to the input power device; and a tray space defined by being surrounded by the first and second tray surfaces and positioned below the component supply unit, and the input power device supports the second tray surface to be movable toward and away from the first tray surface.

In addition, a smart feeding system may be provided in which the smart feeding system further includes a component transfer unit positioned between the input adjusting unit and the component receiving unit in a height direction, and configured to receive the components from the input adjusting unit and transfer the components to the component receiving unit, and the component transfer unit includes a belt member supporting the component dropped from the tray space; and a transfer power device configured to move the belt member toward and away from the component receiving unit.

In addition, according to an aspect of the present disclosure, provided is a control method of a smart feeding system, comprising: (a) computing, by a control unit, component information regarding components to be supplied; (b) controlling, by the control unit, a component supply unit so that the components are supplied to a component receiving unit based on the computed component information; (c) controlling, by the control unit, at least one of the component supply unit, an input adjusting unit, a component transfer unit, and the component receiving unit based on the quantity of the supplied components; and (d) controlling, by the control unit, the component collection unit to change a state of the components delivered to the component collection unit.

In this case, a control method of a smart feeding system may be provided in which the step (a) includes (a1) receiving, by an information computation unit, product information regarding a product to be manufactured using the components; and (a2) computing, by the information computation unit, the component information using the received product information, and the product information includes product specification information regarding specifications of the product and product quantity information regarding a quantity of the product.

In addition, a control method of a smart feeding system may be provided in which the step (a2) includes (a21) computing, by a component information computation module, component specification information regarding specifications of the components to be supplied, using the received product specification information; and (a22) computing, by the component information computation module, component quantity information regarding a quantity of the components to be supplied, using the received product quantity information, and the component information includes the component specification information and the component quantity information.

In this case, a control method of a smart feeding system may be provided in which the step (b) includes (b1) computing, by the information computation unit, supply information using the computed component information; and (b2) controlling, by a power device control unit, a supply power device based on the computed supply information.

In addition, a control method of a smart feeding system may be provided in which the step (b1) includes (b11) computing, by a supply information computation module, supply specification information regarding specifications of the components to be supplied using the computed component specification information; and (b12) computing, by the supply information computation module, supply quantity information regarding a quantity of the components to be supplied using the computed component quantity information, and the component information includes the component specification information and the component quantity information, and the supply information includes the supply specification information and the supply quantity information.

In this case, a control method of a smart feeding system may be provided in which the component supply unit is provided in plurality, and the plurality of component supply units are each configured to supply the components having different specifications, and the step (b2) includes (b21) selecting, by a supply power device control module, at least one of the plurality of component supply units based on the computed supply specification information; (b22) computing, by the supply power device control module, control information for controlling a supply power device provided in the at least one component supply unit using the computed supply quantity information; and (b23) controlling, by the supply power device control module, the supply power device provided in the at least one component supply unit based on the computed control information.

In addition, a control method of a smart feeding system may be provided in which the step (b) includes, prior to the step (b1), (b) computing, by the information computation unit, discharge information using detection information regarding specifications of the components collected in the component collection unit, and the step (b0) includes (b01) generating, by a collected component detection device, detection information regarding the components located in a collection space; (b02) computing, by a collection information computation module, collection specification information regarding the specifications of the components located in the collection space using the generated detection information; (b03) computing, by a discharge information computation module, discharge information using the computed collection specification information and the component information; (b04) controlling, by a blocking power device control module, a blocking power device based on the computed discharge information; and (b05) controlling, by a collection power device control module, a collection power device based on the computed discharge information.

In this case, a control method of a smart feeding system may be provided in which the step (b03) includes (b031) computing, by the discharge information computation module, the discharge information such that the components collected in the collection space are discharged, if the computed collection specification information and the component information are different; the step (b04) includes (b041) controlling, by the first blocking power device control module, the blocking power device such that the first stopper member establishes fluid communication between the collection space and the discharge space; and (b042) controlling, by the second blocking power device control module, the blocking power device such that the second stopper member establishes fluid communication between the discharge space and the outside; and the step (b05) includes (b051) controlling, by the collection power device control module, the collection power device such that the components located in the collection space are discharged to the outside.

In addition, a control method of a smart feeding system may be provided in which the step (c) includes (c1) generating, by a remaining component detection device, detection information regarding a quantity of the components accommodated in a tray member; (c2) computing, by an information computation unit, remaining information regarding the quantity of the components remaining in the tray member using the generated detection information; and (c3) controlling, by a power device control unit, at least one of a supply power device, an input power device, and a transfer power device based on the computed remaining information.

In this case, a control method of a smart feeding system may be provided in which the step (c3) includes (c31) controlling, by a supply power device control module, the supply power device based on the computed remaining information; (c32) controlling, by an input power device control module, the input power device based on the computed remaining information; and (c33) controlling, by a transfer power device control module, the transfer power device based on the computed remaining information.

In addition, a control method of a smart feeding system may be provided in which the step (c31) includes (c311) if the computed remaining information is equal to or greater than a preset reference remaining information, controlling, by the supply power device control module, the supply power device to stop; and (c312) if the computed remaining information is less than the reference remaining information, controlling, by the supply power device control module, the supply power device to operate.

In this case, a control method of a smart feeding system may be provided in which the step (c32) includes (c321) if the computed remaining information is less than a preset reference remaining information, controlling, by the input power device control module, the input power device so that the components accommodated in the tray member are not delivered to the component transfer unit; and (c322) if the computed remaining information is equal to or greater than the reference remaining information, controlling, by the input power device control module, the input power device so that the components accommodated in the tray member are delivered to the component transfer unit.

In addition, a control method of a smart feeding system may be provided in which the step (c33) includes (c331) if the computed remaining information is equal to or greater than a preset reference remaining information, controlling, by the transfer power device control module, the transfer power device so that the components are delivered to the component collection unit; and (c332) if the computed remaining information is less than the reference remaining information, controlling, by the transfer power device control module, the transfer power device to stop.

In this case, a control method of a smart feeding system may be provided in which the step (c) includes (c4) generating, by a collected component detection device, detection information regarding a quantity of components accommodated in a collection space; (c5) computing, by the information computation unit, collection information regarding the components accommodated in the collection space using the generated detection information; and (c6) controlling, by the power device control unit, at least one of a blocking power device and a collection power device based on the computed collection information.

In addition, a control method of a smart feeding system may be provided in which the step (c6) includes (c61) if the computed collection quantity information is equal to or greater than a preset reference quantity information, controlling, by the power device control unit, at least one of the blocking power device and the collection power device so that the components located in a discharge space are not moved to the collection space; and (c62) if the computed collection quantity information is less than the reference quantity information, controlling, by the power device control unit, at least one of the blocking power device and the collection power device so that the components located in the discharge space are moved to the collection space, and the collection quantity information is information regarding a quantity of components accommodated in the collection space.

In this case, a control method of a smart feeding system may be provided in which the step (c61) includes (c611) controlling, by a first blocking power device control module, a first blocking power device such that a first stopper member partitions the collection space and the discharge space; and (c612) controlling, by a collection power device control module, a collection power device such that the components located in the discharge space are prevented from moving into the collection space.

In addition, a control method of a smart feeding system may be provided in which the step (c62) includes (c621) controlling, by the first blocking power device control module, the first blocking power device such that the first stopper member allows fluid communication between the collection space and the discharge space; and (c622) controlling, by the collection power device control module, the collection power device such that the components located in the discharge space are moved into the collection space.

In this case, a control method of a smart feeding system may be provided in which the step (d) includes (d1) generating, by a collected component detection device, detection information regarding a state of each of the components positioned in a collection space; (d2) computing, by an information computation unit, collection information regarding the state of each of the components positioned in the collection space based on the generated detection information; and (d3) controlling, by a power device control unit, at least one of a blocking power device and a vibration power device based on the computed collection information, thereby changing at least one of a position and an orientation of each of the components positioned in the collection space.

In addition, a control method of a smart feeding system may be provided in which the step (d2) includes (d21) computing, by a collection state information computation unit, collection state information regarding the position and orientation of each of the components based on the generated detection information, and the step (d3) includes (d31) if the computed collection state information is different from a preset reference state information, controlling, by a first blocking power device control module, a first blocking power device such that a first stopper member allows fluid communication between the collection space and the discharge space; and (d32) controlling, by a vibration power device control module, a vibration power device such that an external force is applied to each of the components positioned in the collection space, thereby changing at least one of the position and the orientation of each of the components positioned in the collection space.

According to the above configuration, the smart feeding system and the control method thereof according to an embodiment of the present disclosure can continuously supply components.

In addition, the smart feeding system and the control method thereof according to an embodiment of the present disclosure can easily change the components being supplied.

In addition, the smart feeding system and the control method thereof according to an embodiment of the present disclosure can simultaneously supply components having different specifications.

In addition, the smart feeding system and the control method thereof according to an embodiment of the present disclosure can accurately distinguish a plurality of components.

In addition, the smart feeding system and the control method thereof according to an embodiment of the present disclosure can easily and accurately adjust the quantity of the components being supplied.

Advantageous effects of the present disclosure are not limited to the above-described effects, and should be understood to include all effects that can be inferred from the configuration of the disclosure described in the detailed description or claims of the present disclosure.

### BRIEF DESCRIPTION OF THE DRAWINGS

FIG. 1 is a perspective view illustrating a smart feeding system according to an embodiment of the present disclosure.

FIG. 2 is a plan view illustrating the smart feeding system of FIG. 1.

FIG. 3 is an exploded perspective view illustrating the configuration of the smart feeding system of FIG. 1.

FIG. 4 is a perspective view illustrating a component supply unit included in the smart feeding system of FIG. 1.

FIG. 5 is a perspective cross-sectional view illustrating the component supply unit of FIG. 4.

FIG. 6 is a perspective view illustrating an input adjusting unit and a component transfer unit included in the smart feeding system of FIG. 1.

FIG. 7 is an enlarged perspective view illustrating portion A of the input adjusting unit of FIG. 6.

FIG. 8 is a perspective view from a different angle illustrating the input adjusting unit and the component transfer unit included in the smart feeding system of FIG. 1.

FIG. 9 is an enlarged perspective view illustrating portion B of the input adjusting unit of FIG. 8.

FIGS. 10 to 13 include plan views (FIGS. 10 and 12) and perspective views (FIGS. 11 and 13) illustrating states in which a component receiving member of the input adjusting unit shown in FIGS. 6 and 8 is moved.

FIG. 14 is a perspective view illustrating a component receiving unit included in the smart feeding system of FIG. 1.

FIG. 15 is an exploded perspective view illustrating the configuration of the component receiving unit of FIG. 14.

FIG. 16 is a plan view illustrating a receiving conveyor included in the component receiving unit of FIG. 14.

FIG. 17 is a perspective view illustrating a stopper member included in the component receiving unit of FIG. 14.

FIGS. 18 to 21 are perspective views illustrating states in which the stopper member is elevated and lowered with respect to the receiving conveyor.

FIG. 22 is an exploded perspective view illustrating a vibration transfer member included in the component receiving unit of FIG. 14.

FIGS. 23 to 25 are side cross-sectional views illustrating a process in which vibration is applied to components accommodated in the component receiving unit.

FIGS. 26 to 28 are perspective views illustrating a process in which components are transferred by the smart feeding system of FIG. 1.

FIG. 29 is a block diagram illustrating a configuration for implementing a method for controlling the smart feeding system of FIG. 1.

FIG. 30 is a flowchart illustrating a method for controlling the smart feeding system according to an embodiment of the present disclosure.

FIG. 31 is a flowchart illustrating a detailed flow of step S100 in the method for controlling the smart feeding system of FIG. 30.

FIGS. 32 to 34 are flowcharts illustrating a detailed flow of step S200 in the method for controlling the smart feeding system of FIG. 30.

FIGS. 35 to 37 are flowcharts illustrating a detailed flow of step S300 in the method for controlling the smart feeding system of FIG. 30.

FIG. 38 is a flowchart illustrating a detailed flow of step S400 in the method for controlling the smart feeding system of FIG. 30.

### DETAILED DESCRIPTION

Hereinafter, exemplary embodiments of the present disclosure will be described in detail so that those of ordinary skill in the art can readily implement the present disclosure with reference to the accompanying drawings. The present disclosure may be embodied in many different forms and is not limited to the embodiments set forth herein. In the drawings, parts unrelated to the description are omitted for clarity of description of the present disclosure, and throughout the specification, same or similar reference numerals denote same elements.

The words and terms used in the present specification and claims should not be interpreted as being limited to their ordinary or dictionary meanings, but should be construed as having meanings and concepts consistent with the technical spirit of the present disclosure, in accordance with the principle that an inventor may define terms and concepts to best describe their disclosure.

Accordingly, the embodiments described in the present specification and the configurations shown in the drawings correspond to preferred embodiments of the present disclosure, and do not represent all the technical spirit of the present disclosure, so the configurations may have various examples of equivalent and modification that can replace them at the time of filing the present disclosure.

In the following description, in order to clarify the features of the present disclosure, descriptions of some components may be omitted.

The term “fluid communication” used in the following description refers to a state in which one or more members are connected so as to allow fluid flow between them. In an embodiment, the fluid communication may be established by members such as conduits, pipes, or tubes. In the following description, the term “fluid communication” may be used to mean that one or more members are “fluidly connected” to each other.

In addition, in the following description, the term “fluid communication” may also be used to mean that “a plurality of spaces formed in different structures are fluidly communicable with each other” without the different structures being physically connected.

The term “electrical connection” used in the following description refers to a state in which one or more members are connected so as to allow the transmission of electric current or electrical signals between them, and may be variously referred to as “electrical connection,” “energization,” “energizable connection,” “electrically connected state,” “enabled current flow,” “current-conducting state,” or “electrical conduction.” In an embodiment, the electrical connection may be established in a wired form using a wire member or the like, or in a wireless form using Bluetooth, Wi-Fi, RFID, or the like. In an embodiment, the electrical connection may include the meaning of “electrical communication.”

The term “fluid” used in the following description refers to any form of material that flows by external force and whose shape or volume can be changed. In an embodiment, the fluid may be a liquid such as water or a gas such as air.

In the following description, the term “component” refers to any structure used for manufacturing a product. In an embodiment in which the product is provided as a circuit breaker or a relay, the component may be provided as a contact.

In the following description, the term “product” refers to any article manufactured including the above-described component. As described above, in an embodiment in which the component is provided as a contact, the product may be provided as a circuit breaker or a relay or the like.

The terms “above or upper side”, “below or lower side”, “left side”, “right side”, “front side”, and “rear side” used in the following description will be understood with reference to the coordinate system shown throughout the accompanying drawings.

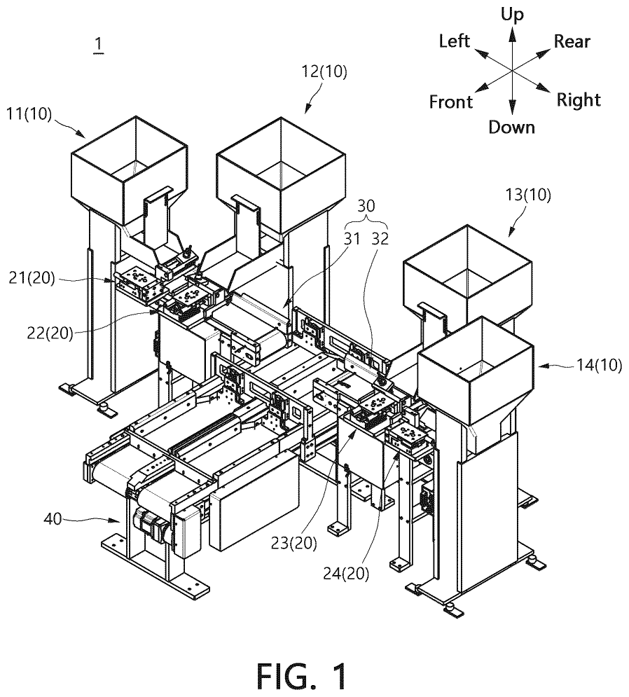

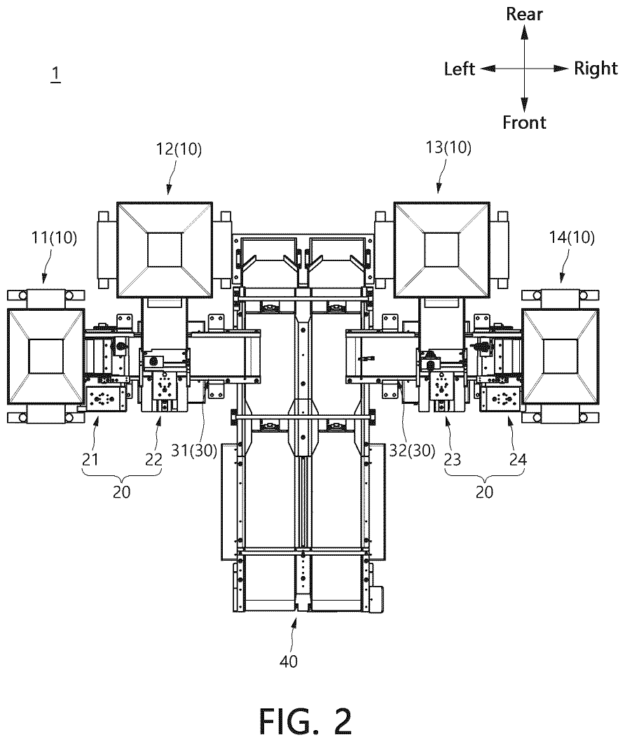

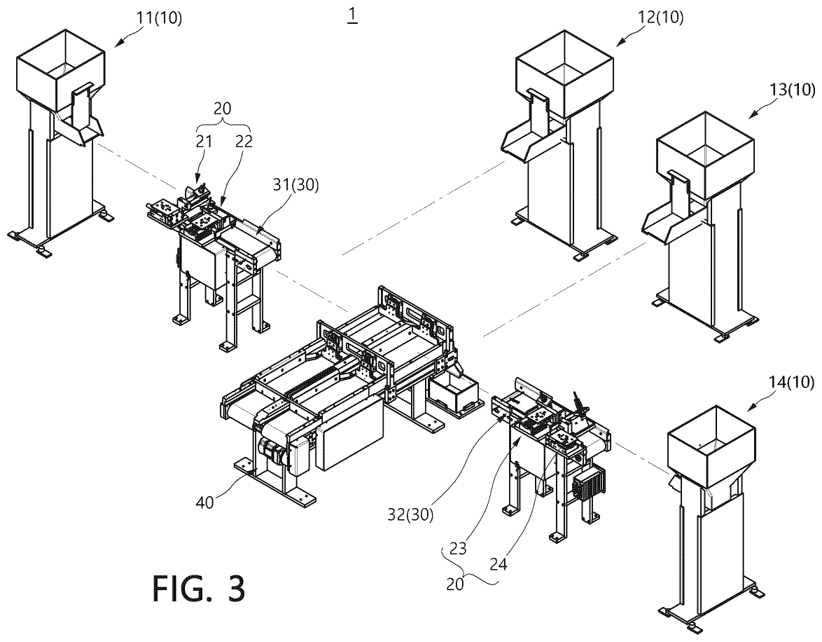

Referring to FIGS. 1 to 3 and 29, the configuration of a smart feeding system 1 according to an embodiment of the present disclosure is illustrated.

The smart feeding system 1 is configured to sort different types of components delivered from the outside and deliver them back to the outside. In other words, the smart feeding system 1 can sort different components according to external needs and provide them to the outside.

In an embodiment in which the component is provided as a contact, the contact is manufactured in a minute size. In addition, although the contact may differ partially depending on the specification, its overall shape is configured to be similar.

Accordingly, in the smart feeding system 1 according to an embodiment of the present disclosure, a plurality of components may be moved along different paths, sorted by a detection device (i.e., a collected component detection device 490, which will be described later), and provided to the outside.

In addition, in the smart feeding system 1 according to an embodiment of the present disclosure, each component is configured to operate in conjunction with one another. That is, the operation of each component included in the smart feeding system 1 may be determined based on the operating state of another component.

Furthermore, the smart feeding system 1 according to an embodiment of the present disclosure can prevent a reduction in the identification capability of the detection device (i.e., the collected component detection device 490, which will be described later). To this end, the smart feeding system 1 applies vibration to the received components so that the detection device can easily identify different components.

In the embodiment illustrated in FIGS. 1 to 3 and 29, the smart feeding system 1 includes a component supply unit 10, an input adjusting unit 20, a component transfer unit 30, and a component collection unit 40.

In one embodiment, the component supply unit 10 may be configured to directly deliver components to the component collection unit 40. In the above embodiment, the input adjusting unit 20 and the component transfer unit 30 may not be separately provided.

The component supply unit 10 receives components from the outside. The component supply unit 10 is in fluid communication with the outside so as to receive components. In addition, the component supply unit 10 may transfer the received components to the input adjusting unit 20. The component supply unit 10 is coupled to and in fluid communication with the input adjusting unit 20.

In this case, the component supply unit 10 may be selectively in fluid communication with the input adjusting unit 20. That is, the components provided to the component supply unit 10 may be transferred to the input adjusting unit 20 or blocked from being transferred, depending on the operating state of the input adjusting unit 20. Accordingly, the amount of components supplied to the input adjusting unit 20, the component transfer unit 30, and the component collection unit 40, which are in fluid communication therewith, can be adjusted.

A plurality of component supply units 10 may be provided. The plurality of component supply units 10 may be configured to receive different components. In addition, the component supply units 10 may be in fluid communication with respective ones of a plurality of input adjusting units 20.

In the illustrated embodiment, the component supply unit 10 includes a first component supply unit 11, a second component supply unit 12, a third component supply unit 13, and a fourth component supply unit 14, which are spaced apart from each other in a direction from left to right.

In the above embodiment, the first component supply unit 11 is coupled to and in fluid communication with the first input adjusting unit 21. The second component supply unit 12 is coupled to and in fluid communication with the second input adjusting unit 22. The third component supply unit 13 is coupled to and in fluid communication with the third input adjusting unit 23, and the fourth component supply unit 14 is coupled to and in fluid communication with the fourth input adjusting unit 24.

In the above embodiment, components having different specifications may be supplied to the first to fourth component supply units 11, 12, 13, and 14. In another embodiment, components having the same first specification may be supplied to the first and second component supply units 11 and 12. In the above embodiment, components having the same second specification may be supplied to the third and fourth component supply units 13 and 14.

The first to fourth component supply units 11, 12, 13, and 14 may operate independently of one another. That is, at least one of the components accommodated in the first to fourth component supply units 11, 12, 13, and 14 may be provided to the component collection unit 40 through the input adjusting unit 20 and the component transfer unit 30.

The first to fourth component supply units 11, 12, 13, and 14 differ in the input adjusting units 20 to which they are coupled and in the specifications of the components provided, but share the same structure. Accordingly, in the following redundant descriptions, the first to fourth component supply units 11, 12, 13, and 14 will be collectively referred to as the component supply unit 10.

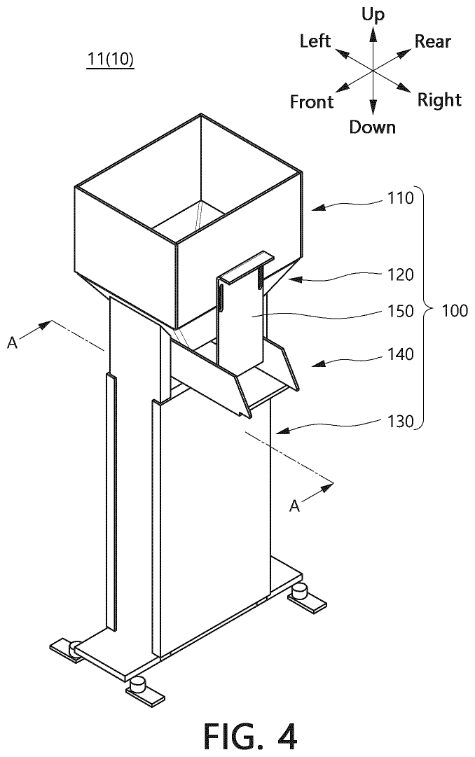

Referring to FIGS. 4, 5, and 29, the component supply unit 10 according to the illustrated embodiment includes a first supply frame 110, a second supply frame 120, a third supply frame 130, a discharge frame 140, a supply door member 150, a supply power device 160, and a supply component detection device 170.

The first supply frame 110 constitutes a part of the outer shape of the component supply unit 10. In the illustrated embodiment, the first supply frame 110 forms one side in the height direction of the component supply unit 10, namely, the upper side. A portion of the first supply frame 110 is formed to be open and is in fluid communication with the outside. Components may be transferred to other components of the component supply unit 10 through the first supply frame 110.

In the embodiment in which the first supply frame 110 forms the upper side of the component supply unit 10, components supplied to the first supply frame 110 may fall by gravity and be easily transferred.

The first supply frame 110 is continuous with the second supply frame 120.

Components delivered to the first supply frame 110 may be transferred to the second supply frame 120.

The first supply frame 110 may have an arbitrary shape that can receive components from the outside and be coupled to the second supply frame 120. In the illustrated embodiment, the first supply frame 110 has a polygonal pillar shape with a rectangular cross-section and a height in the vertical direction.

The supply door member 150 is coupled to one surface of the first supply frame 110, which faces the input adjusting unit 20. In one embodiment, the first supply frame 110 may support the supply door member 150 to be slidable in its height direction, that is, the vertical direction.

Although not illustrated, the first supply frame 110 may support the supply door member 150 to be rotatable in a clockwise or counterclockwise direction. In the above embodiment, one end of the supply door member 150, for example, the upper end, may be hinge-fitted to the first supply frame 110.

In the above embodiment, the supply door member 150 may be opened by the weight of components discharged to the outside through the discharge frame 140.

A first supply space 111 is formed inside the first supply frame 110. The first supply space 111 accommodates components delivered from the outside. The first supply space 111 may have a shape corresponding to the shape of the first supply frame 110. In the illustrated embodiment, the first supply space 111 is formed as a space having a polygonal pillar shape.

The upper and lower sides of the first supply space 111 in the height direction, in the illustrated embodiment, are each formed to be open. The upper side of the first supply space 111 is in fluid communication with the outside to receive components. The lower side of the first supply space 111 is in fluid communication with the second supply space 121 to supply components.

The second supply frame 120 constitutes another part of the outer shape of the component supply unit 10. In the illustrated embodiment, the second supply frame 120 is positioned in the height direction, that is, the vertical direction, between the first supply frame 110 and the third supply frame 130.

The second supply frame 120 is coupled to the first and third supply frames 110 and 130, respectively. In addition, the second supply frame 120 is coupled to the discharge frame 140. In this case, the second supply frame 120 is in fluid communication with the first supply frame 110 and the discharge frame 140, but fluid communication with the third supply frame 130 may be blocked.

Accordingly, the components supplied to the first supply frame 110 proceed to the discharge frame 140 via the second supply frame 120, but are not transferred to the third supply frame 130.

The second supply frame 120 may be formed to have different cross-sectional areas along its height direction. In the illustrated embodiment, the second supply frame 120 may be formed such that its cross-sectional area decreases in a direction opposite to the first supply frame 110, that is, toward the lower side. In other words, the second supply frame 120 may be formed in the shape of an inverted truncated pyramid.

Accordingly, the surfaces of the second supply frame 120 are formed to be inclined inward. Components supplied to the second supply frame 120 can be easily moved downward, that is, in the direction toward the third supply frame 130, along the inclined surfaces.

A second supply space 121 is formed inside the second supply frame 120. The second supply space 121 receives components supplied to the first supply space 111. The second supply space 121 may have a shape corresponding to the shape of the second supply frame 120. In the illustrated embodiment, the second supply space 121 is formed as a space having the shape of an inverted truncated pyramid.

One side in the height direction of the second supply space 121, which is the upper side in the illustrated embodiment, is formed to be open. The second supply space 121 is in fluid communication with the first supply space 111 through the upper side. Another side of the second supply space 121, which faces the input adjusting unit 20 among the respective sides, is also formed to be open. The second supply space 121 is in fluid communication with the discharge space 141 through the same side. Components introduced into the second supply space 121 may flow out to the discharge space 141 through the same side.

The third supply frame 130 constitutes still another part of the outer shape of the component supply unit 10. In the illustrated embodiment, the third supply frame 130 is disposed to face the second supply frame 120 with the discharge frame 140 interposed therebetween in the height direction, that is, in the vertical direction. In other words, the third supply frame 130 forms the lower side of the component supply unit 10.

The third supply frame 130 is coupled to the discharge frame 140. By the discharge frame 140, arbitrary fluid communication between the second supply space 121 and the space formed inside the third supply frame 130 (reference numeral not assigned) may be blocked.

Although not illustrated, an arbitrary structure capable of applying vibration to the component supply unit 10 may be accommodated inside the third supply frame 130. This structure may be operated by the control unit 50, which will be described later, to provide a transfer force that allows components accommodated in the first supply space 111 or the second supply space 121 to flow toward the discharge space 141.

The third supply frame 130 may have an arbitrary shape capable of supporting the first supply frame 110, the second supply frame 120, and the discharge frame 140. In the illustrated embodiment, the third supply frame 130 has a polygonal pillar shape with a rectangular cross-section and a height in the vertical direction. In this case, the cross-sectional shape of the third supply frame 130 may be formed to correspond to the shape of the lower cross-section of the second supply frame 120.

The discharge frame 140 forms a path through which components supplied from the outside are delivered to the outside. The discharge frame 140 is in fluid communication with the second supply space 121 and may form a passage through which components accommodated in the second supply space 121 are transferred to the input adjusting unit 20.

The discharge frame 140 is coupled to the second supply frame 120 and the third supply frame 130, respectively. The discharge frame 140 is positioned between the second supply frame 120 and the third supply frame 130 in its height direction, that is, the vertical direction.

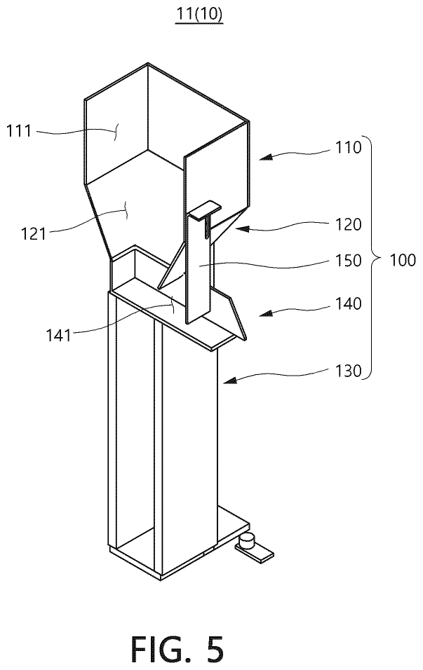

The discharge frame 140 extends in the direction toward the input adjusting unit 20. In the embodiment illustrated in FIG. 5, the discharge frame 140 of the first component supply unit 11 extends toward the right side. The discharge frame 140 may be at least partially positioned above the input adjusting unit 20.

The discharge frame 140 may extend obliquely downward in the direction toward the input adjusting unit 20. That is, the height of the portion of the discharge frame 140 coupled to the second supply frame 120 is greater than the height of the portion of the discharge frame 140 positioned above the input adjusting unit 20. Accordingly, components can be easily moved along the discharge frame 140, which extends at an incline.

The discharge frame 140 may include a plurality of guides (reference numerals not assigned). The guides can prevent unintentional disengagement of components moving along the discharge frame 140. In the illustrated embodiment, the discharge frame 140 includes a pair of guides positioned on the front side and the rear side, that is, in the width direction.

A discharge space 141 is formed inside the discharge frame 140. The discharge space 141 may be defined as a space at least partially surrounded by the discharge frame 140. The discharge space 141 extends in the extending direction of the discharge frame 140, which is the left-right direction in the illustrated embodiment.

The discharge space 141 is in fluid communication with the second supply space 121. Components accommodated in the second supply space 121 may be delivered to the input adjusting unit 20 via the discharge space 141.

The supply door member 150 may be at least partially accommodated in the discharge space 141. In this case, the supply door member 150 may be disposed to be spaced apart from the surface of the discharge frame 140 that surrounds the discharge space 141 from below. Accordingly, components must pass through the space formed between the lower end of the supply door member 150 and the lower surface of the discharge frame 140 in order to be delivered to the input adjusting unit 20. As a result, the amount of components delivered to the input adjusting unit 20 can be adjusted.

The discharge space 141 may have a shape corresponding to the shape of the discharge frame 140. In the illustrated embodiment, the discharge space 141 is formed as a space having a polygonal pillar shape with a rectangular cross-section and a length in the left-right direction, and may extend obliquely downward in the direction toward the input adjusting unit 20.

The supply door member 150 is configured to adjust the amount of components moving along the discharge space 141. The supply door member 150 can at least partially close the discharge space 141 to adjust the size of the discharge space 141.

The supply door member 150 is coupled to the first supply frame 110. In one embodiment, the supply door member 150 may be coupled to the first supply frame 110 to be vertically movable. In the above embodiment, the size of the discharge space 141 is adjusted according to the vertical movement of the supply door member 150, thereby adjusting the amount of components supplied to the input adjusting unit 20.

The supply door member 150 extends in the height direction of the first supply frame 110, that is, in the vertical direction in the illustrated embodiment. A height-direction end of the supply door member 150, which faces the discharge frame 140—specifically, the lower end—may be disposed to be spaced apart from the lower surface of the discharge frame 140.

The supply door member 150 may have an arbitrary shape that is coupled to the first supply frame 110, is at least partially accommodated in the discharge space 141, and is capable of adjusting the amount of components being supplied. In the illustrated embodiment, the supply door member 150 is provided in the form of a polygonal plate having a length in the vertical direction. In this case, a bent handle portion (reference numeral not assigned) is formed at a height-direction end of the supply door member 150 opposite to the discharge frame 140, that is, at the upper end, so that it can be gripped by a worker. The worker can press the handle portion to move the supply door member 150 up and down.

The supply power device 160 applies vibration to the first and second supply frames 110 and 120. Due to the vibration, components accommodated in the first and second supply spaces 111 and 121 may be vibrated and moved to the discharge frame 140. In the above embodiment, it can be said that the component supply unit 10 is provided in the form of a hopper feeder.

The supply power device 160 may be provided in an arbitrary form capable of applying vibration to move components accommodated in the first and second supply spaces 111 and 121. In one embodiment, the supply power device 160 may be configured to include a motor and an asymmetric mass.

The supply power device 160 is electrically connected to a supply power device control module 910 of the control unit 50. The operation of the supply power device 160 may be controlled according to control information computed by the supply power device control module 910.

The supply component detection device 170 is configured to generate detection information on the quantity of components moved to the input adjusting unit 20 through the discharge frame 140. The detection information generated by the supply component detection device 170 is delivered to the information computation unit 800 and may be used to compute information on the quantity of components already supplied. In the above embodiment, the quantity of components delivered from the component supply unit 10 to the component collection unit 40 can be more accurately controlled.

Components provided to the component supply unit 10 are transferred to the input adjusting unit 20.

The input adjusting unit 20 receives the components supplied from the component supply unit 10 and delivers them to the component transfer unit 30. In this case, the input adjusting unit 20 may be configured to control the amount of components supplied from the component supply unit 10 or whether the components are supplied.

The input adjusting unit 20 is coupled to the component supply unit 10. The input adjusting unit 20 is in fluid communication with the discharge space 141 of the component supply unit 10 and can receive components. In this case, the input adjusting unit 20 may be selectively in fluid communication with the discharge space 141. This is achieved by the operation of a tray member 210, which will be described later.

The input adjusting unit 20 is coupled to the component transfer unit 30. The input adjusting unit 20 is in fluid communication with the component transfer unit 30 and may deliver the received components to the component transfer unit 30.

The input adjusting unit 20 is electrically connected to the control unit 50. Detection information generated in relation to the operating state of the input adjusting unit 20 may be delivered to the control unit 50. In addition, the input adjusting unit 20 may be controlled and operated according to control information computed by the control unit 50.

A plurality of input adjusting units 20 may be provided. The plurality of input adjusting units 20 may be coupled to and in fluid communication with different component supply units 10, respectively. In addition, the plurality of input adjusting units 20 may be coupled to and in fluid communication with different component transfer units 30, respectively.

In the illustrated embodiment, the input adjusting unit 20 includes a first input adjusting unit 21, a second input adjusting unit 22, a third input adjusting unit 23, and a fourth input adjusting unit 24, which are spaced apart from each other in a direction from left to right.

In the above embodiment, the first input adjusting unit 21 is coupled to and in fluid communication with the first component supply unit 11 and the first component transfer unit 31. The second input adjusting unit 22 is coupled to and in fluid communication with the second component supply unit 12 and the first component transfer unit 31. The third input adjusting unit 23 is coupled to and in fluid communication with the third component supply unit 13 and the second component transfer unit 32, and the fourth input adjusting unit 24 is coupled to and in fluid communication with the fourth component supply unit 14 and the second component transfer unit 32.

In the above embodiment, components having different specifications may be supplied to the first to fourth input adjusting units 21, 22, 23, and 24. In another embodiment, components having the same first specification may be supplied to the first and second input adjusting units 21 and 22, and components having the same second specification may be supplied to the third and fourth input adjusting units 23 and 24. It will be understood that the specifications of the components supplied to the first to fourth input adjusting units 21, 22, 23, and 24 may vary depending on the specifications of the components supplied to the first to fourth component supply units 11, 12, 13, and 14.

The first to fourth input adjusting units 21, 22, 23, and 24 differ in the component supply units 10 and component transfer units 30 to which they are coupled, but share the same structure. Accordingly, in the following redundant descriptions, the first to fourth input adjusting units 21, 22, 23, and 24 will be collectively referred to as the input adjusting unit 20.

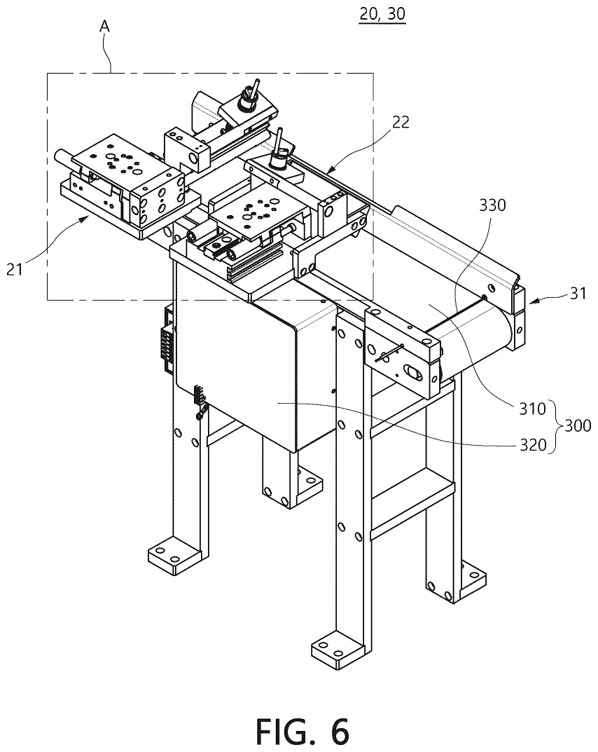

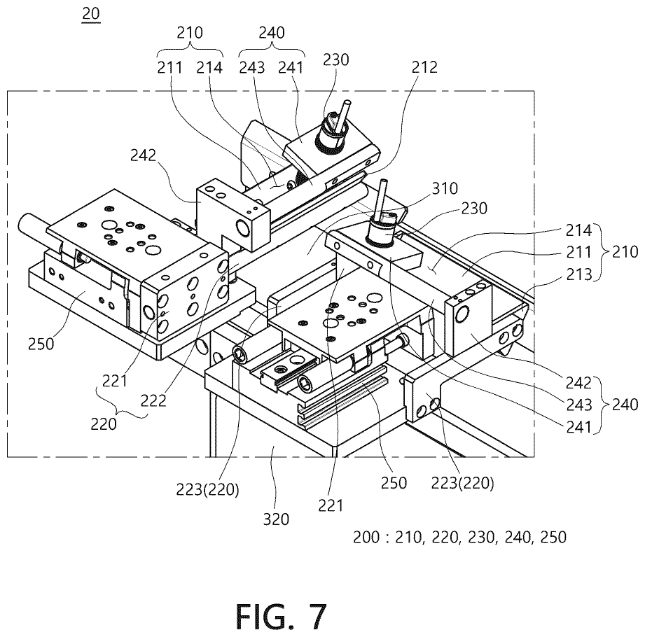

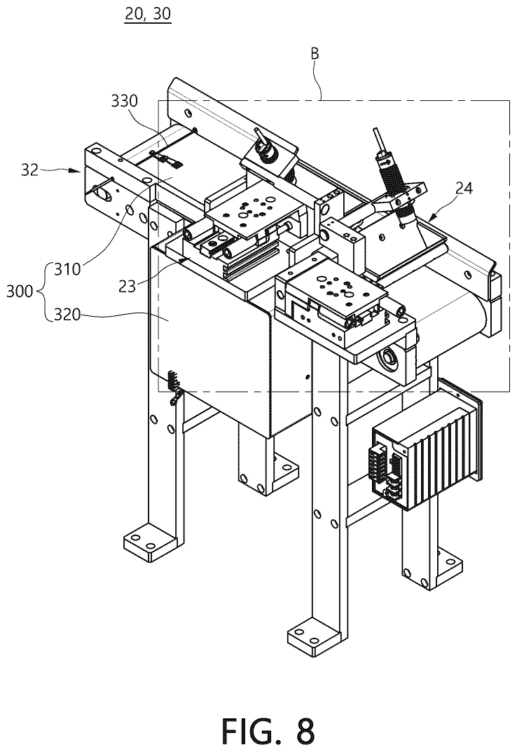

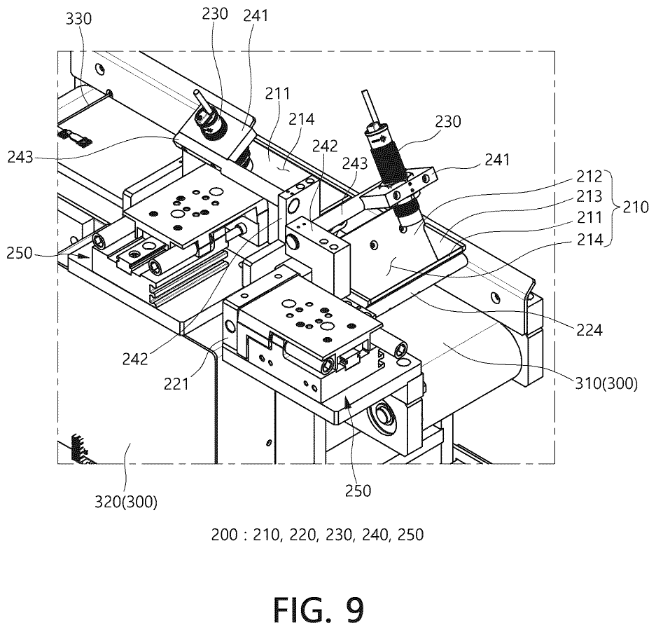

Referring to FIGS. 6 to 13, the input adjusting unit 20 according to the illustrated embodiment includes a tray member 210, an adjustment frame 220, a remaining component detection device 230, a detection frame 240, and an input power device 250.

The tray member 210 primarily receives components supplied from the component supply unit 10. A space (a tray space 214, which will be described later) is formed inside the tray member 210 to accommodate the components. In this case, one side of the space of the tray member 210 remains open at all times, while the other side can be selectively opened and closed. Accordingly, the tray member 210 can either accommodate the received components or discharge the accommodated components and deliver them to the component transfer unit 30.

The tray member 210 is positioned adjacent to the component supply unit 10.

Specifically, the tray member 210 is located below one end in the longitudinal direction of the discharge frame 140 and can receive components that drop from the discharge frame 140.

The tray member 210 is positioned adjacent to the component transfer unit 30. Specifically, the tray member 210 is positioned above a belt member 310 of a transfer conveyor 300 and can deliver the received components to the belt member 310.

The tray member 210 is coupled to the adjustment frame 220. Specifically, the tray member 210 may be coupled to the input power device 250 by the adjustment frame 220. By the power applied from the input power device 250, the space of the tray member 210 can be opened and closed.

The tray member 210 is positioned adjacent to the remaining component detection device 230. The remaining component detection device 230 may generate detection information regarding the amount of components accommodated in the space of the tray member 210.

The tray member 210 is coupled to the input power device 250. Power applied by the input power device 250 may be transmitted to the tray member 210 through the adjustment frame 220.

In the illustrated embodiment, the tray member 210 includes a first tray surface 211, a second tray surface 212, a third tray surface 213, and a tray space 214.

The first tray surface 211 forms one surface of the tray member 210. The first tray surface 211 is positioned offset toward the discharge frame 140 of the component supply unit 10. The first tray surface 211 is formed to be inclined with respect to the vertical direction. In the illustrated embodiment, the first tray surface 211 extends obliquely in a direction opposite to the discharge frame 140 and downward.

The first tray surface 211 is positioned adjacent to the second tray surface 212. The first tray surface 211 may be in contact with or spaced apart from the second tray surface 212. As will be described later, since the second tray surface 212 is configured to be movable by the input power device 250, it will be understood that the contact and spacing are achieved by the movement of the second tray surface 212.

That is, the first tray surface 211 is fixedly positioned at a preset location by an adjustment support angle 223.

The first tray surface 211 is coupled to the third tray surface 213. In the illustrated embodiment, each side in the width direction of the first tray surface 211 is coupled to the third tray surface 213.

The first tray surface 211 partially surrounds the tray space 214. In the illustrated embodiment, the first tray surface 211 surrounds the tray space 214 on one side facing the discharge frame 140.

The second tray surface 212 forms another surface of the tray member 210. The second tray surface 212 is positioned opposite to the discharge frame 140. That is, the second tray surface 212 is positioned facing the discharge frame 140 with the first tray surface 211 interposed therebetween.

The second tray surface 212 is formed to be inclined with respect to the vertical direction. In the illustrated embodiment, the second tray surface 212 extends obliquely in a direction toward the discharge frame 140 and downward.

The second tray surface 212 is positioned adjacent to the first tray surface 211. The second tray surface 212 may be in contact with or spaced apart from the first tray surface 211. In the illustrated embodiment, the lower end of the second tray surface 212 and the lower end of the first tray surface 211 may be in contact with or spaced apart from each other. Accordingly, the lower side of the tray space 214 may be closed or opened, so that the components accommodated in the tray space 214 may be delivered to the component transfer unit 30 or blocked from being delivered.

The second tray surface 212 partially surrounds the tray space 214. In the illustrated embodiment, the second tray surface 212 surrounds the tray space 214 on one side opposite to the discharge frame 140.

The second tray surface 212 is configured to be movable. Specifically, the second tray surface 212 is coupled to an adjustment bar 222 and may be moved toward or away from the first tray surface 211 by the input power device 250 coupled to the adjustment bar 222.

The second tray surface 212 is coupled to an adjustment bar 222 of the adjustment frame 220. The adjustment bar 222 is coupled to the input power device 250 by an adjustment support block 221 and may transmit power to the second tray surface 212. In the illustrated embodiment, one side of the second tray surface 212, which is opposite to the first tray surface 211 or the tray space 214, is coupled to the adjustment bar 222.

The third tray surface 213 forms the remaining surface of the tray member 210. The third tray surface 213 is positioned in a direction different from the first tray surface 211 and the second tray surface 212. In the illustrated embodiment, the third tray surface 213 is positioned in the width direction of the first tray surface 211 or the second tray surface 212.

The third tray surface 213 is coupled to the first tray surface 211. The third tray surface 213 is fixedly coupled to the first tray surface 211. In one embodiment, when the second tray surface 212 moves toward the discharge frame 140, the third tray surface 213 may come into contact with the second tray surface 212.

A plurality of third tray surfaces 213 may be provided. The plurality of third tray surfaces 213 may be spaced apart in the width direction of the first tray surface 211 or the second tray surface 212 and may be respectively coupled to both ends of the first tray surface 211 in the width direction. In the illustrated embodiment, a pair of third tray surfaces 213 is provided and respectively coupled to both ends of the first tray surface 211 in the width direction. The pair of third tray surfaces 213 is disposed to face each other with the first tray surface 211 interposed therebetween.

The third tray surface 213 partially surrounds the tray space 214. In the illustrated embodiment, the third tray surface 213 surrounds the tray space 214 in the width direction of the first tray surface 211 or the second tray surface 212.

The third tray surface 213 may have a shape corresponding to the first tray surface 211 and the second tray surface 212. In the illustrated embodiment, the third tray surface 213 is formed in the shape of a polygonal plate having a triangular cross-section with a vertex positioned at the lower side, corresponding to the shapes of the first and second tray surfaces 211 and 212, and having a thickness in the width direction of the first tray surface 211 or the third tray surface 213.

The tray space 214 is a space for accommodating components provided from the discharge frame 140. The tray space 214 is partially surrounded by the first to third tray surfaces 211, 212, and 213, respectively.

In the illustrated embodiment, one side of the tray space 214 that faces the discharge frame 140 is surrounded by the first tray surface 211. The opposite side of the tray space 214, which faces away from the discharge frame 140, is surrounded by the second tray surface 212. In addition, each side of the tray space 214 in the width direction is surrounded by the pair of third tray surfaces 213.

One side of the tray space 214 in the height direction, which is the upper side in the illustrated embodiment, is formed to be open. As described above, the tray space 214 is located below the end of the discharge frame 140, and the supplied components may be accommodated in the tray space 214 through the upper side.

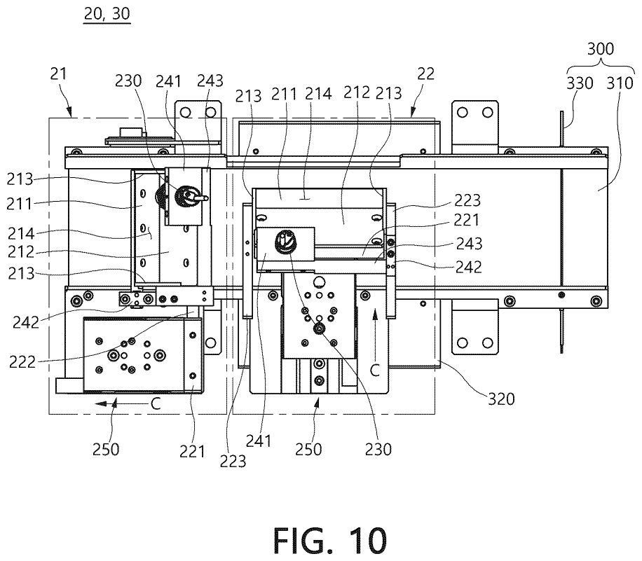

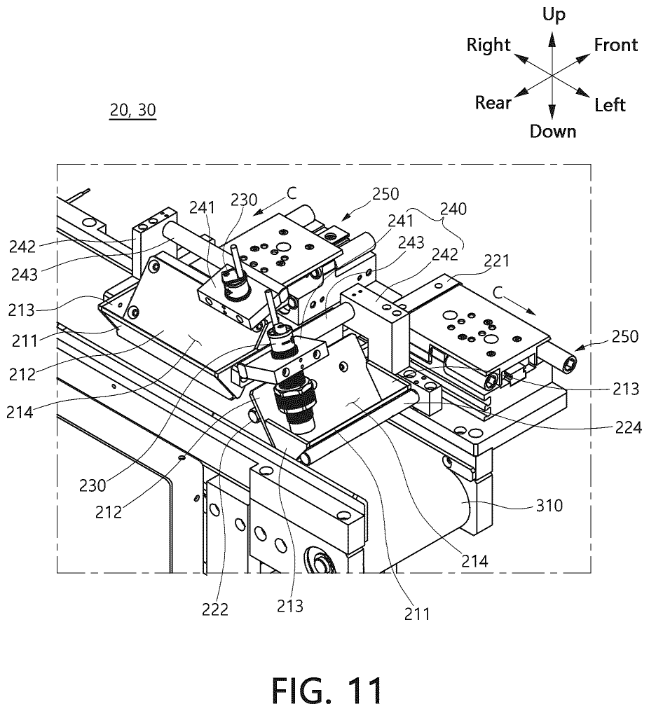

The lower side, that is, the other side in the height direction of the tray space 214, can be opened or closed by the movement of the second tray surface 212. That is, as illustrated in FIGS. 10 and 11, when the second tray surface 212 moves in the closing direction (C), the lower side of the tray space 214 is closed, and the components provided from the discharge frame 140 are not delivered to the component transfer unit 30.

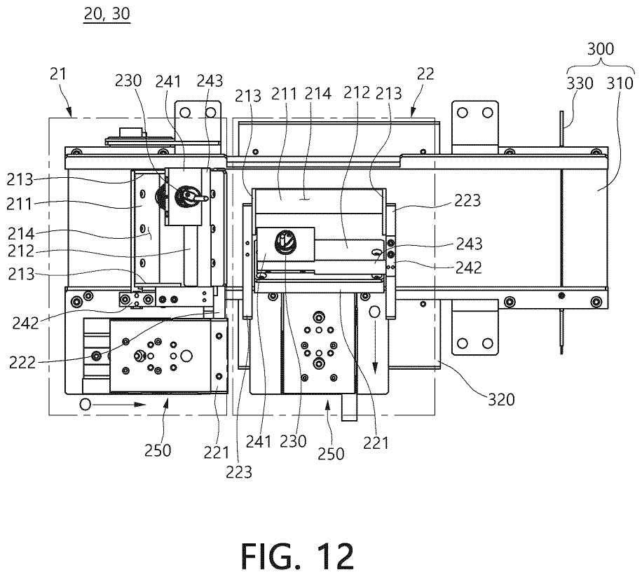

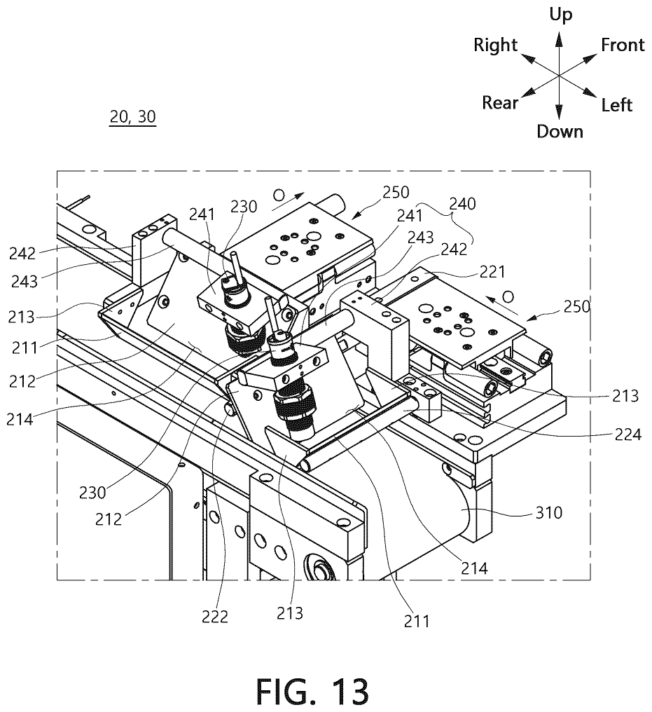

In addition, as illustrated in FIGS. 12 and 13, when the second tray surface 212 moves in the opening direction (O), the lower side of the tray space 214 is opened, allowing the components provided from the discharge frame 140 to be delivered to the component transfer unit 30.

The tray space 214 may have a shape corresponding to the shapes of the first to third tray surfaces 211, 212, and 213. In the illustrated embodiment, the tray space 214 is formed as a space having a triangular prism shape with one edge positioned at the lower side.

The adjustment frame 220 supports the tray member 210. Some components of the adjustment frame 220 fixedly support certain components of the tray member 210, while other components of the adjustment frame 220 may movably support other components of the tray member 210. The adjustment frame 220 is coupled to the tray member 210.

The adjustment frame 220 is coupled to the detection frame 240. The adjustment frame 220 may fixedly support the detection frame 240.

The adjustment frame 220 is coupled to the input power device 250. When the input power device 250 is operated, certain components of the adjustment frame 220 and the above-mentioned other components of the tray member 210 coupled to the adjustment frame 220 may be moved.

In the illustrated embodiment, the adjustment frame 220 includes an adjustment support block 221, an adjustment bar 222, an adjustment support angle 223, and a support bar 224.

The adjustment support block 221 is a portion of the adjustment frame 220 that is coupled to the input power device 250. The adjustment support block 221 is configured to be movable by the operation of the input power device 250.

The adjustment support block 221 may be configured differently depending on the first to fourth input adjusting units 21, 22, 23, and 24. In the illustrated embodiment, the adjustment support blocks 221 provided in the first and fourth input adjusting units 21 and 24 are respectively coupled to the input power device 250 and the adjustment bar 222. In addition, the adjustment support blocks 221 provided in the second and third input adjusting units 22 and 23 may be directly coupled to the second tray surface 212.

In any case, it is sufficient that the adjustment support block 221 is coupled to the input power device 250 and is capable of transmitting the power generated by the input power device 250 to the second tray surface 212.

The adjustment bar 222 transmits the power generated by the input power device 250 to the second tray surface 212. The adjustment bar 222 is coupled to the adjustment support block 221 and the second tray surface 212, respectively. The adjustment bar 222 may move together with the adjustment support block 221 and the second tray surface 212.

The adjustment bar 222 may be provided in some of the plurality of input adjusting units 20. In the illustrated embodiment, the adjustment bar 222 is provided in the first and fourth input adjusting units 21 and 24. In the above embodiment, the adjustment bar 222 may move the second tray surface 212 in accordance with the direction of the power applied by the input power device 250.

That is, in the illustrated embodiment, the power in the left-right direction applied by the input power device 250 may be transmitted to the second tray surface 212 through the adjustment bar 222. Accordingly, the second tray surface 212 may be moved in a direction toward or away from the component supply unit 10.

The adjustment bar 222 extends in the moving direction of the second tray surface 212. In the illustrated embodiment, the adjustment bar 222 extends in the front-rear direction. One end of the adjustment bar 222 in the extending direction, specifically the front end in the illustrated embodiment, is coupled to the adjustment support block 221. One side of the outer circumference of the adjustment bar 222, which faces the discharge frame 140, is coupled to the second tray surface 212.

The adjustment bar 222 may be provided in an arbitrary form capable of transmitting the movement of the adjustment support block 221 to the second tray surface 212. In the illustrated embodiment, the adjustment bar 222 may have a shape of a cylinder having a circular cross-section and a length in the front-rear direction.

The adjustment support angle 223 fixedly supports the above-mentioned components of the tray member 210. In addition, the adjustment support angle 223 fixedly supports the detection frame 240.

The adjustment support angle 223 is positioned in the width direction of the first tray surface 211. The adjustment support angle 223 is coupled to the third tray surface 213. Accordingly, the first tray surface 211, which is coupled to the third tray surface 213, can also be fixedly supported by the adjustment support angle 223.

The adjustment support angle 223 is coupled to the input power device 250. In this case, the adjustment support angle 223 is coupled to a fixed component of the input power device 250. In the illustrated embodiment, the adjustment support angle 223 is fixedly coupled to a plate member (reference numeral not assigned) that supports the fixed component of the input power device 250.

The adjustment support angle 223 may have an arbitrary shape capable of fixedly supporting the above-mentioned component of the tray member 210 and the detection frame 240. In the illustrated embodiment, the adjustment support angle 223 includes a one portion that extends in the horizontal direction and is coupled to the above-mentioned component of the tray member 210 and the detection frame 240, and the other portion that is continuous with the one portion, extends in the vertical direction, and is coupled to the input power device 250.

The adjustment support angle 223 may be provided in some of the plurality of input adjusting units 20. In the illustrated embodiment, the adjustment support angle 223 is provided in the second and third input adjusting units 22 and 23. That is, it will be understood that the adjustment support angle 223 and the adjustment bar 222 may be selectively provided.

The support bar 224 supports the first tray surface 211. The support bar 224 is positioned between the first tray surface 211 and the discharge frame 140. The support bar 224 is fixedly coupled to the first tray surface 211. The support bar 224 is also fixedly coupled to a detection device support block 242.

The support bar 224 may extend in the same direction as the adjustment bar 222. In the illustrated embodiment, the support bar 224 extends in the width direction of the first tray surface 211. One end of the support bar 224 in the extending direction is coupled to the detection device support block 242. One side of the outer circumference of the support bar 224, which faces the first tray surface 211, is coupled to the first tray surface 211.

The remaining component detection device 230 generates detection information regarding the amount of components accommodated in the tray space 214. The detection information generated by the remaining component detection device 230 is delivered to the control unit 50 and is used to compute input amount information. The remaining component detection device 230 is electrically connected to the control unit 50.

The remaining component detection device 230 is positioned adjacent to the tray member 210. The remaining component detection device 230 is at least partially accommodated in the tray space 214. In the illustrated embodiment, the lower end of the remaining component detection device 230 is positioned within the tray space 214.

The remaining component detection device 230 may be provided in an arbitrary form capable of detecting the amount of components accommodated in the tray space 214. In one embodiment, the remaining component detection device 230 may be provided as a distance sensor that generates detection information based on the distance to the components. In the above embodiment, the remaining component detection device 230 may be implemented as an IR sensor, a laser sensor, or the like.

The remaining component detection device 230 is coupled to the detection frame 240. Specifically, the remaining component detection device 230 is fixedly coupled to a detection device coupling block 241. As described above, since the detection frame 240 is not moved regardless of the operation of the input power device 250, it will be understood that the remaining component detection device 230 also does not move.

The detection frame 240 supports the remaining component detection device 230. The detection frame 240 is fixedly coupled to a plate member (reference numeral not assigned) that supports the input power device 250 and is not moved.

The detection frame 240 is coupled to either the plate member (reference numeral not assigned) or the adjustment support angle 223. Specifically, in the illustrated embodiment, the detection frame 240 provided in the first and fourth input adjusting units 21 and 24 is coupled to the plate member (reference numeral not assigned), and the detection frame 240 provided in the second and third input adjusting units 22 and 23 is coupled to the adjustment support angle 223.

In the illustrated embodiment, the detection frame 240 includes a detection device coupling block 241, a detection device support block 242, and a detection device support bar 243.

The detection device coupling block 241 is coupled to and supports the remaining component detection device 230. The detection device coupling block 241 is located on one side in the height direction of the tray space 214, specifically on the upper side in the illustrated embodiment. The detection device coupling block 241 is coupled to the detection device support block 242 by the detection device support bar 243.

The detection device support block 242 is a portion of the detection frame 240 that is coupled to either the plate member (reference numeral not assigned) or the adjustment support angle 223. The detection device support block 242 is coupled to a stationary component. Accordingly, it will be understood that the detection frame 240 and the remaining component detection device 230 coupled thereto do not move.

As described above, the detection device support block 242 provided in the first and fourth input adjusting units 21 and 24 is coupled to the plate member (reference numeral not assigned). In addition, the detection device support block 242 provided in the second and third input adjusting units 22 and 23 is coupled to the adjustment support angle 223.

The detection device support bar 243 couples the detection device coupling block 241 and the detection device support block 242. The detection device support bar 243 extends in the width direction of the first and second tray surfaces 211 and 212. A part of the outer circumference of the detection device support bar 243 is coupled to the detection device coupling block 241. One end of the detection device support bar 243 in the extending direction is coupled to the detection device support block 242.

The input power device 250 provides power to move the second tray surface 212. The input power device 250 is coupled to the second tray surface 212.

The input power device 250 may be provided in an arbitrary form capable of generating power to move the second tray surface 212. In the illustrated embodiment, the input power device 250 is provided in the form of a pneumatic cylinder including a movable part and a fixed part. Alternatively, the input power device 250 may be implemented as a hydraulic cylinder or a motor or the like.

The input power device 250 is coupled to the adjustment frame 220. Specifically, the input power device 250 is directly coupled to the adjustment support block 221. The movable part of the input power device 250 can move together with the adjustment support block 221.

The input power device 250 is coupled to the second tray surface 212. Specifically, the movable part of the input power device 250 is coupled to the second tray surface 212 by the adjustment support block 221 or by the adjustment support block 221 and the adjustment bar 222. The fixed part of the input power device 250 may be fixedly coupled to a plate member (reference numeral not assigned).

The input power device 250 is electrically connected to the control unit 50. The operation of the input power device 250 may be controlled by the control unit 50.

The component transfer unit 30 receives components delivered from the input adjusting unit 20. The component transfer unit 30 may transfer the received components and deliver them to the component collection unit 40. The component transfer unit 30 is coupled to and in fluid communication with the input adjusting unit 20 and the component collection unit 40, respectively.

The component transfer unit 30 is located on one side in the height direction of the input adjusting unit 20, specifically on the lower side in the illustrated embodiment. Specifically, the component transfer unit 30 is located below the tray member 210 so that when components accommodated in the tray space 214 fall, they can land on the component transfer unit 30.

The component transfer unit 30 is located on one side in the height direction of the component collection unit 40, specifically on the upper side in the illustrated embodiment. Specifically, the component transfer unit 30 is located above the discharge space 460 of the receiving conveyor 400, so that components transferred by the component transfer unit 30 may fall and enter the discharge space 460.

The component transfer unit 30 is electrically connected to the control unit 50. A component provided in the component transfer unit 30 (i.e., a transfer power device 320, which will be described later) may be controlled by the control unit 50.

The component transfer unit 30 may be provided in an arbitrary form capable of transferring seated components. In one embodiment, the component transfer unit 30 may be provided in the form of a conveyor belt.

A plurality of component transfer units 30 may be provided. The plurality of component transfer units 30 may be coupled to and in fluid communication with the plurality of input adjusting units 20 and the component collection unit 40, respectively. In the illustrated embodiment, two component transfer units 30 are provided, including a first component transfer unit 31 located on the left side and a second component transfer unit 32 located on the right side.

The first component transfer unit 31 is coupled to and in fluid communication with the first and second input adjusting units 21 and 22 and the component collection unit 40, respectively. The first component transfer unit 31 delivers components transferred from the first and second input adjusting units 21 and 22 to the component collection unit 40. In this case, the components transferred by the first component transfer unit 31 are delivered to a first receiving conveyor 400a of the component collection unit 40.

The second component transfer unit 32 is coupled to and in fluid communication with the third and fourth input adjusting units 23 and 24 and the component collection unit 40, respectively. The second component transfer unit 32 delivers components transferred from the third and fourth input adjusting units 23 and 24 to the component collection unit 40. In this case, the components transferred by the second component transfer unit 32 are delivered to a second receiving conveyor 400b of the component collection unit 40.

As will be described later, the first and second receiving conveyors 400a and 400b are physically divided by a dividing conveyor partition 422. Accordingly, it will be understood that the components transferred by the first component transfer unit 31 and the second component transfer unit 32 are not mixed with each other in the component collection unit 40.

The first and second component transfer units 31 and 32 differ in the input adjusting units 21, 22, 23, and 24 and the receiving conveyors 400a and 400b to which they are coupled, but have the same structure and operating method. Accordingly, in the following descriptions, the identical parts of the first and second component transfer units 31 and 32 will be collectively referred to as the component transfer unit 30.

In the embodiment illustrated in FIGS. 6 to 13, the component transfer unit 30 is configured as a transfer conveyor 300. In the above embodiment, the transfer conveyor 300 includes a belt member 310, a transfer power device 320, and a filtering member 330.

The belt member 310 supports components supplied to the component transfer unit 30. The belt member 310 is driven by the transfer power device 320 to transfer the supplied components.

The belt member 310 extends between the input adjusting unit 20 and the component collection unit 40. In the illustrated embodiment, the belt member 310 extends in the left-right direction. One end of the belt member 310 in the extending direction is located below the input adjusting unit 20 positioned at the far left or right. The other end of the belt member 310 in the extending direction is located above the component collection unit 40. In addition, another portion of the belt member 310 is located below the other input adjusting units 20.

Specifically, the left end of the first component transfer unit 31 is located below the first input adjusting unit 21, the right end of the first component transfer unit 31 is located above the first receiving conveyor 400a, and a portion of the remaining part is located below the second input adjusting unit 22.

In addition, the right end of the second component transfer unit 32 is located below the fourth input adjusting unit 24, the left end of the second component transfer unit 32 is located above the second receiving conveyor 400b, and a portion of the remaining part is located below the third input adjusting unit 23.

The belt member 310 may be formed of a material having a predetermined coefficient of friction. This is to ensure that the components seated on the belt member 310 are stably transferred by the belt member 310 without slipping.

The belt member 310 may be operated by the transfer power device 320.

The transfer power device 320 provides power for operating the belt member 310. The transfer power device 320 is coupled to the belt member 310.

The transfer power device 320 may be provided in an arbitrary form capable of generating and supplying power to operate the belt member 310. In the illustrated embodiment, the transfer power device 320 is provided in the form of a motor. In the above embodiment, the transfer power device 320 may move the belt member 310 in its longitudinal direction, that is, in the direction toward the left or right.

The transfer power device 320 is electrically connected to the control unit 50. The operation of the transfer power device 320 may be controlled by the control unit 50.

The filtering member 330 is configured to adjust the amount of components delivered from the component transfer unit 30 to the component collection unit 40. The filtering member 330 is positioned adjacent to the belt member 310. In this case, the filtering member 330 is spaced apart from the belt member 310 in the height direction. In the illustrated embodiment, the filtering member 330 is positioned above the belt member 310.

Accordingly, the components transferred by the belt member 310 may be delivered to the component collection unit 40 in an amount that can pass through the space formed between the belt member 310 and the filtering member 330.

The filtering member 330 is positioned adjacent to one end of the belt member 310 in the extending direction, which faces the component collection unit 40. In the illustrated embodiment, the filtering member 330 provided in the first component transfer unit 31 is positioned adjacent to the right end of the belt member 310, and the filtering member 330 provided in the second component transfer unit 32 is positioned adjacent to the left end of the belt member 310.

The component collection unit 40 receives components transferred by the component transfer unit 30. The component collection unit 40 is coupled to and in fluid communication with the component transfer unit 30. In addition, the component collection unit 40 may provide the received components to the outside. Furthermore, the component collection unit 40 may discharge the received components to the outside. The component collection unit 40 is in fluid communication with the outside.

The component collection unit 40, according to an embodiment of the present disclosure, may be configured to discharge all of the received components when the specification of the components to be provided to the outside is changed. To this end, the following process may be performed first: the operation of the component supply unit 10 is stopped, the input of components by the input adjusting unit 20 is halted, all components seated on the component transfer unit 30 are transferred to the component collection unit 40, and the components transferred to the component collection unit 40 are then discharged to the outside.

This will be described later in detail.

In addition, the component collection unit 40 according to an embodiment of the present disclosure may be configured to adjust the alignment state of the received components. Specifically, as the supply of components progresses, the components may be received in irregular orientations. In such a case, a means for identifying the components (i.e., a collected component detection device 490, which will be described later) may fail to accurately identify the components.

Accordingly, in the embodiment of the present disclosure, the component collection unit 40 applies vibration (V) to the received components to scatter them, thereby enabling the above-described means to accurately identify the components. This will also be described later in detail.

The component collection unit 40 is coupled to and in fluid communication with the plurality of component transfer units 31 and 32, respectively. In the illustrated embodiment, the component collection unit 40 is positioned between the first component transfer unit 31 located on the left side and the second component transfer unit 32 located on the right side. In other words, the first and second component transfer units 31 and 32 are disposed to face each other with the component collection unit 40 interposed therebetween.

The components delivered to the component collection unit 40 may be provided to the outside and used for manufacturing a product. In addition, the components delivered to the component collection unit 40 may be discharged to an external bucket (B) in order to initiate the supply of different components.

The component collection unit 40 is electrically connected to the control unit 50. The detection information generated by the above-described means may be delivered to the control unit 50. In addition, a component provided in the component collection unit 40 may be controlled by the control unit 50.

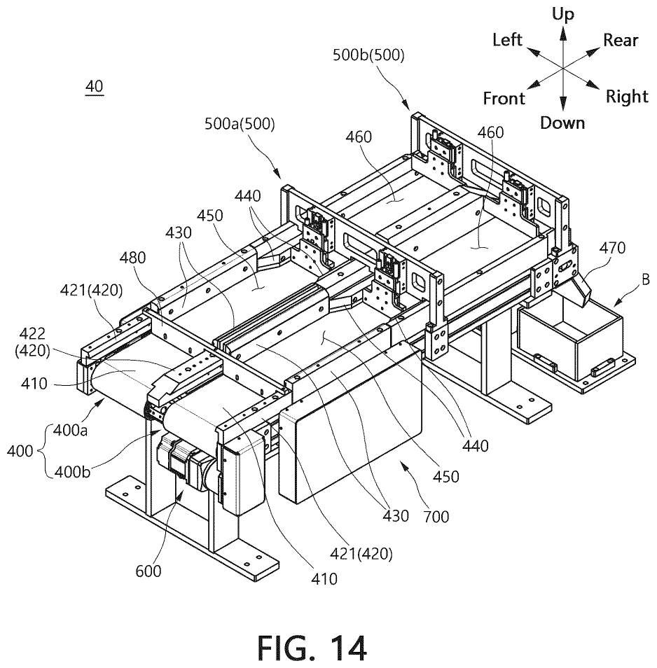

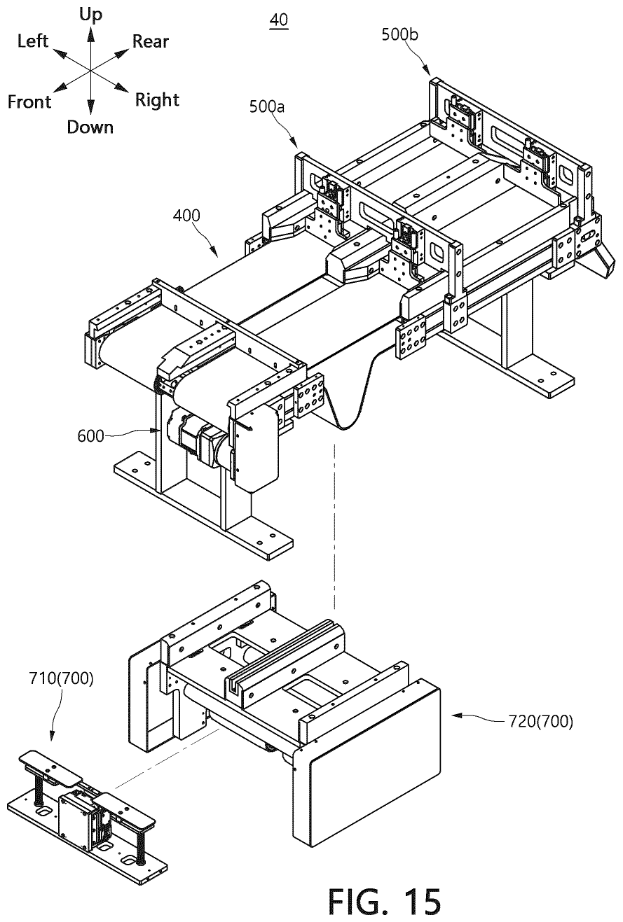

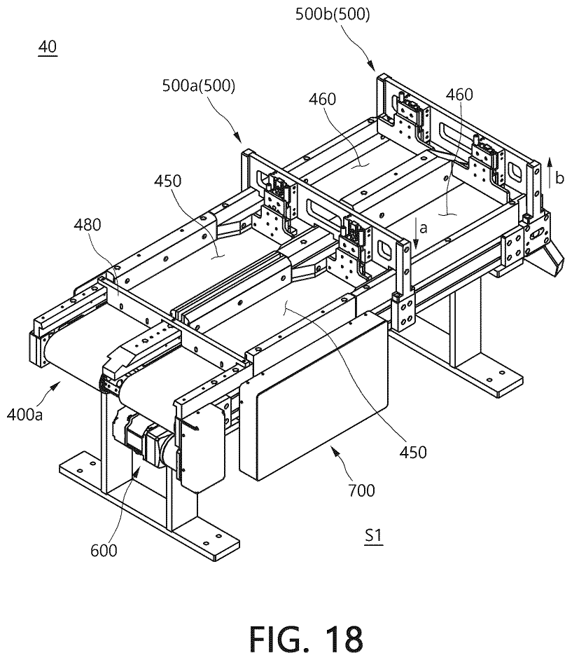

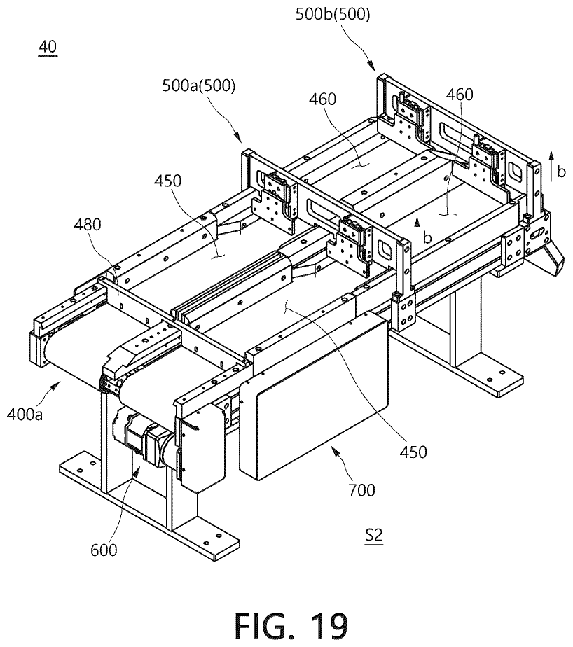

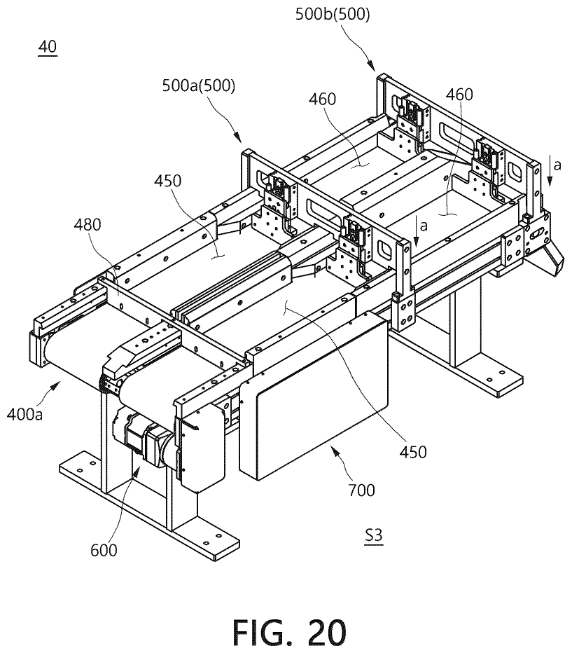

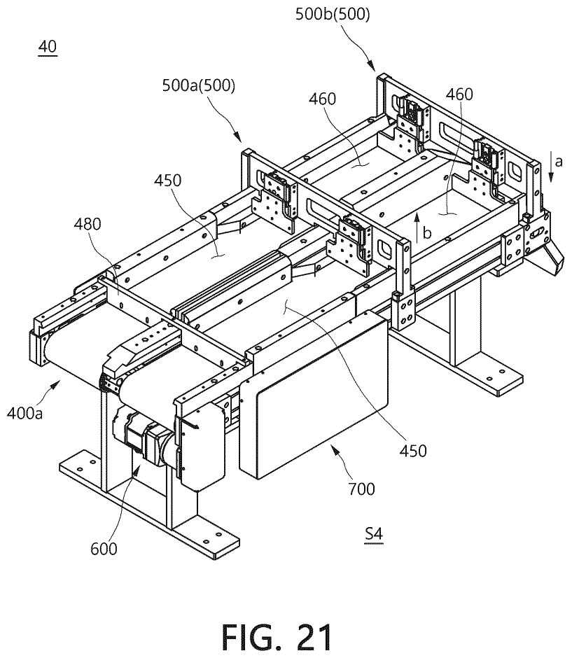

In the embodiment illustrated in FIGS. 14 to 25, the component collection unit 40 includes a receiving conveyor 400, a stopper member 500, a collection power device 600, and a vibration transfer member 700.

The receiving conveyor 400 serves to accommodate components delivered to the component collection unit 40. In addition, the receiving conveyor 400 may provide the accommodated components to the outside (i.e., for the purpose of product manufacturing) or discharge the accommodated components to an external bucket (B). The receiving conveyor 400 is in fluid communication with the outside.

The receiving conveyor 400 may be provided in an arbitrary form capable of moving or vibrating the seated components. In the illustrated embodiment, the receiving conveyor 400 is provided in the form of a conveyor.

The receiving conveyor 400 is coupled to the component transfer unit 30. In this case, the receiving conveyor 400 may accommodate the respective components delivered by the plurality of component transfer units 31 and 32 without mixing them. To this end, the receiving conveyor 400 includes a first receiving conveyor 400a for accommodating components delivered from the first component transfer unit 31, and a second receiving conveyor 400b for accommodating components delivered from the second component transfer unit 32.

The first receiving conveyor 400a and the second receiving conveyor 400b are physically divided by a dividing conveyor partition 422. Accordingly, the components accommodated in the first receiving conveyor 400a and the second receiving conveyor 400b are not mixed with each other. As a result, the accommodated components can be accurately provided to the outside according to the required specifications.

The first and second receiving conveyors 400a and 400b differ in the component transfer units 30 to which they are connected, but have the same structure and function. Accordingly, in the following descriptions, the common parts of the first and second receiving conveyors 400a and 400b will be collectively referred to as the receiving conveyor 400.

In the embodiment illustrated in FIGS. 14 to 21, the receiving conveyor 400 includes a vibration belt member 410, a conveyor partition 420, a bumper member 430, a guide member 440, a collection space 450, a discharge space 460, a discharge slope member 470, a blocking partition 480, and a collected component detection device 490.

The vibration belt member 410 supports the components supplied to and received in the component collection unit 40. The vibration belt member 410 may be moved by power provided from the collection power device 600. In addition, the vibration belt member 410 may be vibrated by vibration (v) provided from the vibration transfer member 700.

The vibration belt member 410 extends in the longitudinal direction of the receiving conveyor 400, which is the front-rear direction in the illustrated embodiment. In the above embodiment, the vibration belt member 410 may extend in a direction perpendicular to the belt member 310.

The blocking partition 480 is positioned adjacent to one end of the vibration belt member 410 in its extending direction, specifically the front end in the illustrated embodiment. Components moved toward the front side along the vibration belt member 410 are prevented from falling out to the outside by the blocking partition 480.

The discharge slope member 470 and a bucket (B) are positioned adjacent to the other end of the vibration belt member 410 in its extending direction, specifically the rear end in the illustrated embodiment. Components moved toward the rear side along the vibration belt member 410 may be discharged into the bucket (B) via the discharge slope member 470.

That is, the components seated on the vibration belt member 410 are moved along the extending direction of the vibration belt member 410, but components that are to be provided to the outside are prevented from being unintentionally discharged by the blocking partition 480. In addition, components that are to be discharged to the outside may be discharged into the bucket (B) via the discharge slope member 470 as the stopper member 500 opens.

The vibration belt member 410 surrounds the collection space 450 and the discharge space 460 from below in the height direction, specifically in the lower side in the illustrated embodiment. In this case, it will be understood that when the stopper member 500 is raised, the components accommodated in the collection space 450 and the discharge space 460 can be moved by the vibration belt member 410.

The vibration belt member 410 may be formed of a material having a predetermined coefficient of friction. This is to ensure that the components seated on the vibration belt member 410 are stably moved and vibrated by the vibration belt member 410 without slipping. In one embodiment, the vibration belt member 410 may be formed of a material including rubber.

The vibration belt member 410 is coupled to the collection power device 600. The vibration belt member 410 may be operated by the collection power device 600. The vibration belt member 410 may be moved in its extending direction, that is, toward the front side or the rear side, by the collection power device 600.

The vibration belt member 410 is coupled to the vibration transfer member 700. Specifically, one side of the vibration belt member 410 in the extending direction, which is the front side in the illustrated embodiment, is coupled to the vibration transfer member 700. The components located in that portion may be vibrated and rearranged by the vibration (v) provided by the vibration transfer member 700.

The conveyor partition 420 forms a part of the outer shape of the receiving conveyor 400. The conveyor partition 420 partially surrounds the space formed inside the receiving conveyor 400. The conveyor partition 420 may extend a predetermined length in the height direction, that is, in the vertical direction in the illustrated embodiment.

The conveyor partition 420, together with the vibration belt member 410, may define the collection space 450 and the discharge space 460. In the illustrated embodiment, the conveyor partition 420 surrounds the collection space 450 and the discharge space 460 in the width direction, that is, the left-right direction.

Accordingly, the components seated on the vibration belt member 410 are prevented from being unintentionally discharged in the width direction of the receiving conveyor 400.

In the illustrated embodiment, the conveyor partition 420 includes an outer conveyor partition 421 and a dividing conveyor partition 422.

The outer conveyor partition 421 surrounds the space formed inside the receiving conveyor 400, that is, the collection space 450 and the discharge space 460, from the outer side in the width direction. The outer conveyor partition 421 defines the outer side in the width direction of the receiving conveyor 400.

The outer conveyor partition 421 extends in the longitudinal direction of the receiving conveyor 400, which is the front-rear direction in the illustrated embodiment. In this case, the extension length of the outer conveyor partition 421 may be equal to the extension length of the vibration belt member 410.

A plurality of outer conveyor partitions 421 may be provided. The plurality of outer conveyor partitions 421 are spaced apart from each other in the width direction and may form the outer shape of the receiving conveyor 400 at different positions. In the illustrated embodiment, a pair of outer conveyor partitions 421 is provided and spaced apart in the left-right direction. The pair of outer conveyor partitions 421 is disposed to face each other with the dividing conveyor partition 422, the collection space 450, and the discharge space 460 interposed therebetween.

The dividing conveyor partition 422 divides the receiving conveyor 400 into a first receiving conveyor 400a and a second receiving conveyor 400b. By the dividing conveyor partition 422, the components seated in the first receiving conveyor 400a and the second receiving conveyor 400b are prevented from being mixed with each other.

The dividing conveyor partition 422 extends in the longitudinal direction of the receiving conveyor 400, which is the front-rear direction in the illustrated embodiment. The dividing conveyor partition 422 may extend to a predetermined height. In one embodiment, the dividing conveyor partition 422 may extend to the same height as the outer conveyor partition 421.

The bumper member 430 is configured to prevent damage that may occur when components collide with the conveyor partition 420 due to vibration applied to the collection space 450. The bumper member 430 may be formed of a material having a predetermined elasticity or buffering force so as to absorb the impact imparted by the vibrating components. In one embodiment, the bumper member 430 may be formed of a rubber or silicone material.

The bumper member 430 may partially surround the conveyor partition 420. The bumper member 430 extends in the same direction as the conveyor partition 420, which is the front-rear direction in the illustrated embodiment. In the illustrated embodiment, the bumper member 430 may be formed with a length corresponding to the length of the collection space 450. In other words, the bumper member 430 is configured to surround the collection space 450 in the width direction.

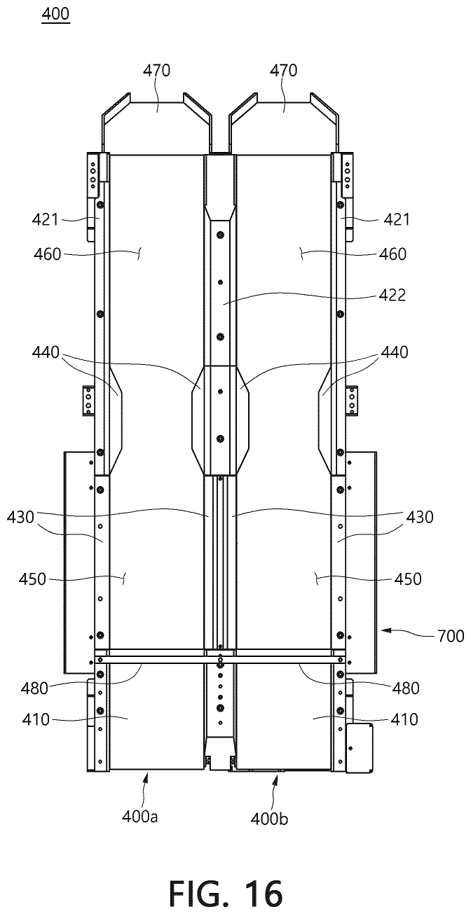

A plurality of bumper members 430 may be provided. The plurality of bumper members 430 may be respectively coupled to the plurality of conveyor partitions 420. In the illustrated embodiment, a total of four bumper members 430 are provided. The four bumper members 430 may be arranged to surround a pair of outer conveyor partitions 421 and a pair of dividing conveyor partitions 422 (see FIG. 16).

The guide member 440 serves to gather inward the components that are moved by the vibration belt member 410 from one of the collection space 450 and the discharge space 460 to the other. By means of the guide member 440, the components that were positioned adjacent to the outer conveyor partition 421 can be moved toward the dividing conveyor partition 422, that is, toward the inner side in the width direction.

Accordingly, excessive scattering of the components accommodated in the collection space 450 or the discharge space 460 can be prevented. As a result, the process of supplying or discharging the components can be carried out smoothly.

The guide member 440 may extend in the extending direction of the conveyor partition 420, which is the front-rear direction in the illustrated embodiment. In this case, the guide member 440 may extend between the collection space 450 and the discharge space 460, such that one portion is positioned in the collection space 450 and the remaining portion is positioned in the discharge space 460. The guide member 440 may be configured to protrude inward in the width direction of the receiving conveyor 400, thereby reducing the width of the collection space 450 and the discharge space 460.

The guide member 440 may be divided into a plurality of sections along its longitudinal direction. In the illustrated embodiment, the guide member 440 includes a first section that extends inward in the width direction at an incline, a second section that is continuous with the first section and extends parallel to the conveyor partition 420, and a third section that is continuous with the second section and extends outward in the width direction at an incline.

The guide member 440 may be formed to have a height in the height direction of the conveyor partition 420, which is the vertical direction in the illustrated embodiment.

The guide member 440 is coupled to the conveyor partition 420. The guide member 440 may be positioned on one side in the width direction of the conveyor partition 420, facing either the collection space 450 or the discharge space 460. In addition, a plurality of guide members 440 may be provided and respectively coupled to the plurality of conveyor partitions 420.

In the illustrated embodiment, a total of four guide members 440 are provided. A pair of guide members 440 provided in the first receiving conveyor 400a is respectively positioned to the right of the outer conveyor partition 421 and to the left of the dividing conveyor partition 422, and are arranged to face each other with the collection space 450 and the discharge space 460 interposed therebetween.

In addition, another pair of guide members 440 provided in the second receiving conveyor 400b is respectively positioned to the left of the outer conveyor partition 421 and to the right of the dividing conveyor partition 422, and are arranged to face each other with the collection space 450 and the discharge space 460 interposed therebetween.

The collection space 450 is defined as a portion of the space surrounded by the vibration belt member 410 and the conveyor partition 420. The collection space 450 is located on one side in the longitudinal direction of the receiving conveyor 400, specifically on the front side in the illustrated embodiment. The components accommodated in the collection space 450 may be provided to the outside and used for manufacturing a product. That is, the collection space 450 accommodates components that are to be provided to the outside.

One side of the collection space 450 in the height direction, specifically the upper side in the illustrated embodiment, is formed to be open. The components accommodated in the collection space 450 may be grasped through the upper side by a robot (not shown) or the like and provided to the outside.

The other side of the collection space 450 in the height direction, specifically the lower side in the illustrated embodiment, is surrounded by the vibration belt member 410. Each side of the collection space 450 in the width direction, specifically the left and right sides in the illustrated embodiment, is surrounded by the conveyor partition 420.

One side of the collection space 450 in the longitudinal direction, specifically the front side in the illustrated embodiment, is enclosed and blocked by the blocking partition 480. The components accommodated in the collection space 450 are prevented from moving toward the front side by the blocking partition 480.

The other side of the collection space 450 in the longitudinal direction, specifically the rear side in the illustrated embodiment, can be opened or closed by a first stopper member 500a. As will be described later, since the first stopper member 500a is provided to be vertically movable, the collection space 450 may be brought into fluid communication with the discharge space 460 or may be blocked from such communication by the first stopper member 500a.

The vibration transfer member 700 is positioned on the other side in the height direction of the collection space 450, that is, on the lower side. Vibration (v) generated by the vibration transfer member 700 may be transmitted to the collection space 450. Accordingly, the components accommodated in the collection space 450 are rearranged by the vibration (v), allowing the collected component detection device 490 to identify the components more accurately.

The discharge space 460 is defined as another portion of the space surrounded by the vibration belt member 410 and the conveyor partition 420. The discharge space 460 is located on the other side in the longitudinal direction of the receiving conveyor 400, specifically on the rear side in the illustrated embodiment. The components transferred by the component transfer unit 30 may be delivered to the discharge space 460. In addition, the components accommodated in the discharge space 460 may be discharged to an external bucket (B). That is, the discharge space 460 accommodates components transferred from the component transfer unit 30 and components to be discharged to the outside.

One side of the discharge space 460 in the height direction, specifically the upper side in the illustrated embodiment, is formed to be open. The components transferred by the component transfer unit 30 may be delivered to the discharge space 460 through the upper side.

The other side of the discharge space 460 in the height direction, specifically the lower side in the illustrated embodiment, is surrounded by the vibration belt member 410. Each side of the discharge space 460 in the width direction, specifically the left and right sides in the illustrated embodiment, is surrounded by the conveyor partition 420.

One side of the discharge space 460 in the longitudinal direction, specifically the front side in the illustrated embodiment, can be opened or closed by the first stopper member 500a. The discharge space 460 may be brought into fluid communication with or blocked from the collection space 450 by the first stopper member 500a.

The other side of the discharge space 460 in the longitudinal direction, specifically the rear side in the illustrated embodiment, can be opened or closed by a second stopper member 500b. The discharge space 460 may be brought into fluid communication with, or blocked from, the outside (or an external bucket (B)) by the second stopper member 500b.

The discharge slope member 470 forms a path for components discharged from the discharge space 460 to the outside (i.e., the bucket (B)). The discharge slope member 470 is located at the other end in the longitudinal direction of the receiving conveyor 400, that is, the rear end.

The discharge slope member 470 may extend at an incline toward one side in the height direction. In the illustrated embodiment, the discharge slope member 470 extends at an incline toward the lower rear side. In one embodiment, the bucket (B) may be positioned on an imaginary line extending from the discharge slope member 470.

A plurality of discharge slope members 470 may be provided. The plurality of discharge slope members 470 may be respectively positioned in the first receiving conveyor 400a and the second receiving conveyor 400b. In the illustrated embodiment, a pair of discharge slope members 470 is provided, with each being arranged in the first and second receiving conveyors 400a and 400b, respectively.

The blocking partition 480 surrounds one side in the longitudinal direction of the collection space 450, specifically the front side in the illustrated embodiment. The components accommodated in the collection space 450 are prevented from being unintentionally discharged in the longitudinal direction by the blocking partition 480. In other words, the blocking partition 480 is configured to block fluid communication between the collection space 450 and the outside along the longitudinal direction.

The blocking partition 480 extends in the width direction of the receiving conveyor 400, specifically in the left-right direction in the illustrated embodiment. One end of the blocking partition 480 in the extending direction, specifically the left end in the illustrated embodiment, may be coupled to the outer conveyor partition 421 located on the left side. The other end of the blocking partition 480 in the extending direction, specifically the right end in the illustrated embodiment, may be coupled to the outer conveyor partition 421 located on the right side.

The blocking partition 480 may be formed to have a predetermined height. In the illustrated embodiment, the blocking partition 480 is formed to have a height greater than or equal to that of the conveyor partition 420 in the vertical direction.

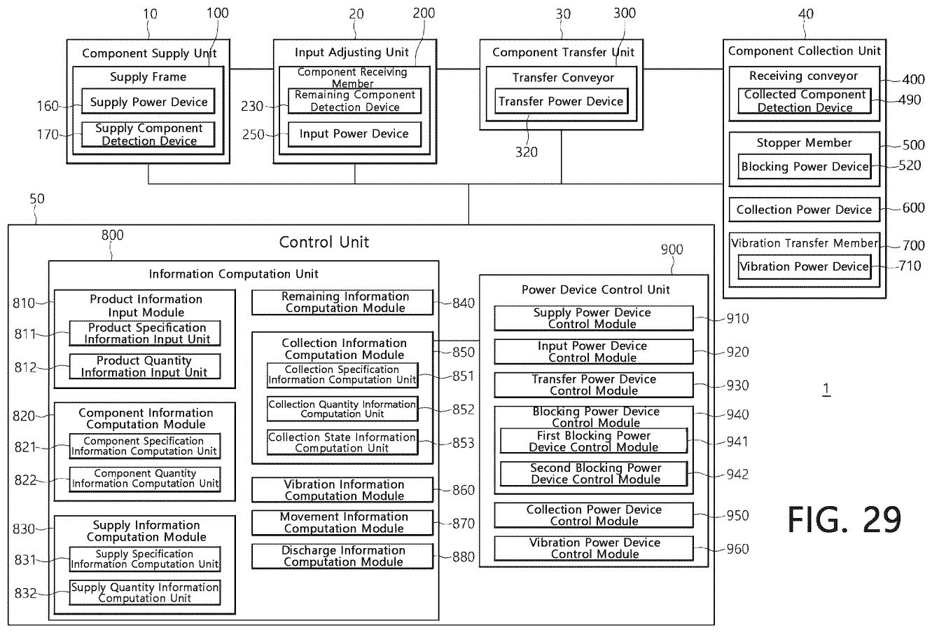

The collected component detection device 490 generates detection information regarding the type of components accommodated in the collection space 450 (see FIG. 29). In other words, the collected component detection device 490 generates detection information for identifying the components accommodated in the collection space 450. The detection information generated by the collected component detection device 490 is delivered to the control unit 50 and may be used to compute information about the components to be selected by an external robot (not shown) or the like.

The collected component detection device 490 may be provided in any form capable of identifying components using the external shape of the components accommodated in the collection space 450. In one embodiment, the collected component detection device 490 may be implemented as a vision camera sensor or the like that identifies components using visual information.

The stopper member 500 allows or blocks fluid communication between the collection space 450 and the discharge space 460. In addition, the stopper member 500 allows or blocks fluid communication between the discharge space 460 and the outside. By means of the stopper member 500, components accommodated in one of the collection space 450 and the discharge space 460 may be transferred to the other, or components accommodated in the discharge space 460 may be discharged to the outside.

The stopper member 500 is provided to be vertically movable. In one embodiment, a portion of the stopper member 500 is fixedly coupled to the conveyor partition 420, and another portion may be coupled to the fixed portion so as to be vertically movable.

A plurality of stopper members 500 may be provided. The plurality of stopper members 500 are spaced apart along the longitudinal direction of the receiving conveyor 400 and may respectively allow or block fluid communication between the collection space 450 and the discharge space 460, and allow or block fluid communication between the discharge space 460 and the outside.

In the illustrated embodiment, the stopper member 500 includes a first stopper member 500a located on the front side and a second stopper member 500b located on the rear side. The first stopper member 500a may allow or block fluid communication between the collection space 450 and the discharge space 460. The second stopper member 500b may allow or block fluid communication between the discharge space 460 and the outside.

The first stopper member 500a and the second stopper member 500b may operate independently of each other. In addition, the first stopper member 500a and the second stopper member 500b may operate in conjunction with each other. Accordingly, the collection space 450, the discharge space 460, and the outside may be placed in fluid communication with, or isolated from, one another in various configurations, and a detailed description thereof will be provided later.

The first and second stopper members 500a and 500b differ in their placement and the targets whose fluid communication they block, but they have the same structure and function. Accordingly, in the following descriptions, the common parts of the first and second stopper members 500a and 500b will be collectively referred to as the stopper member 500.

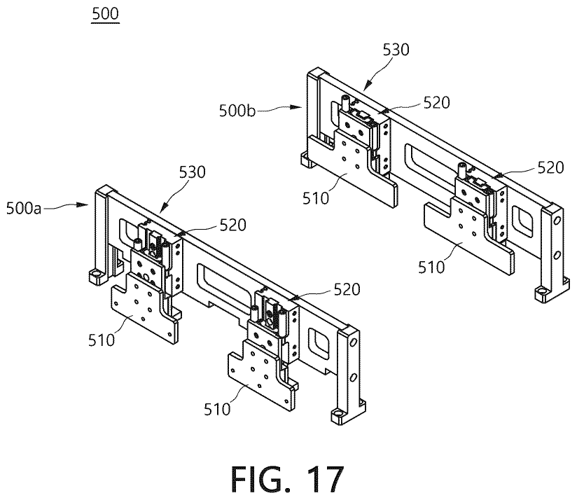

In the embodiment illustrated in FIG. 17, the stopper member 500 includes a blocking plate 510, a blocking power device 520, and a blocking frame 530.

The blocking plate 510 blocks fluid communication between the collection space 450, the discharge space 460, and the outside. The blocking plate 510 is vertically movably coupled to the blocking frame 530 by the blocking power device 520.

When the blocking plate 510 is lowered, fluid communication between the collection space 450, the discharge space 460, and the outside can be blocked. When the blocking plate 510 is raised, fluid communication between the collection space 450, the discharge space 460, and the outside can be allowed.

A plurality of blocking plates 510 may be provided. The plurality of blocking plates 510 are spaced apart in the width direction of the receiving conveyor 400 and may be provided to be vertically movable in the first receiving conveyor 400a and the second receiving conveyor 400b, respectively. In the illustrated embodiment, a pair of blocking plates 510 is provided and is vertically movably provided in the first and second receiving conveyors 400a and 400b, respectively.

In this case, the blocking plate 510 included in the first stopper member 500a may be disposed at a location where the guide member 440 is provided, that is, between the collection space 450 and the discharge space 460. In addition, the blocking plate 510 included in the second stopper member 500b may be disposed at a location where the guide member 440 is not provided, that is, within the discharge space 460.

Accordingly, as illustrated in FIG. 17, it will be understood that the width length of the blocking plate 510 included in the first stopper member 500a is formed to be equal to or less than the width length of the blocking plate 510 included in the second stopper member 500b.

The blocking power device 520 provides power for raising and lowering the blocking plate 510. One component of the blocking power device 520 may be coupled to the blocking plate 510, and another component may be coupled to the blocking frame 530. The above components of the blocking power device 520 may be coupled to each other in a vertically movable manner. Accordingly, it can be said that the blocking plate 510 is vertically movably coupled to the blocking frame 530 by the blocking power device 520.

The blocking power device 520 may be provided in any form that allows the blocking plate 510 to be vertically movably coupled to the blocking frame 530. In one embodiment, the blocking power device 520 may be provided in the form of a pneumatic cylinder, similar to the input power device 250. In another embodiment, the blocking power device 520 may be provided in the form of a motor.

A plurality of blocking power devices 520 may be provided. The plurality of blocking power devices 520 may respectively support the plurality of blocking plates 510 to be vertically movable. In the illustrated embodiment, a pair of blocking power devices 520 is provided and is respectively coupled to a pair of blocking plates 510 and a single blocking frame 530.

The blocking frame 530 is the portion of the stopper member 500 that is fixedly coupled to the receiving conveyor 400. The blocking frame 530 is fixedly coupled to the conveyor partition 420, specifically to the outer conveyor partition 421.

The blocking frame 530 is coupled to the blocking power device 520. The blocking frame 530 may support the blocking plate 510 to be vertically movable via the blocking power device 520.

The blocking frame 530 extends in the width direction of the receiving conveyor 400, specifically in the left-right direction in the illustrated embodiment. One end of the blocking frame 530 in the extending direction, specifically the left end in the illustrated embodiment, is coupled to the outer conveyor partition 421 provided in the first receiving conveyor 400a. The other end of the blocking frame 530 in the extending direction, specifically the right end in the illustrated embodiment, is coupled to the outer conveyor partition 421 provided in the second receiving conveyor 400b.

The collection power device 600 provides power for moving the vibration belt member 410 in its longitudinal direction. The collection power device 600 is coupled to and supported by the receiving conveyor 400. In the illustrated embodiment, the collection power device 600 is located on one side in the longitudinal direction of the receiving conveyor 400, specifically on the front side. The collection power device 600 is coupled to the vibration belt member 410 and is capable of moving the vibration belt member 410.

The collection power device 600 is electrically connected to the control unit 50. The operation of the collection power device 600 may be controlled by the control unit 50.

The collection power device 600 may be provided in any form capable of moving the vibration belt member 410 in one direction or the other along the longitudinal direction and maintaining the vibration belt member 410 in a stopped state after it has moved a preset distance. In one embodiment, the collection power device 600 may be provided in the form of a servo motor.

In the above embodiment, the direction, time, and distance by which the collection power device 600 moves the vibration belt member 410 can be precisely controlled.

The vibration transfer member 700 provides vibration (v) to the components accommodated in the collection space 450. The components accommodated in the collection space 450 may be rearranged by the vibration (v). Accordingly, the collected component detection device 490 can identify the components more accurately.

The vibration transfer member 700 is coupled to the receiving conveyor 400.

Specifically, the vibration transfer member 700 is arranged in contact with the vibration belt member 410, which surrounds the collection space 450 from below. In other words, the vibration transfer member 700 is disposed to face the collection space 450 with the vibration belt member 410 interposed therebetween.

In one embodiment, the vibration transfer member 700 may be in contact with the vibration belt member 410. In the above embodiment, the vibration (v) generated by the vibration transfer member 700 can be more effectively transmitted to the components accommodated in the collection space 450.

The vibration transfer member 700 is electrically connected to the control unit 50. The operation of the vibration transfer member 700 may be controlled by the control unit 50.

In the illustrated embodiment, the vibration transfer member 700 includes a vibration power device 710 and a vibration frame 720.

The vibration power device 710 is controlled by the control unit 50 to generate vibration (v). The generated vibration (v) may be transmitted to the components accommodated in the collection space 450 through the vibration belt member 410.

The vibration power device 710 is electrically connected to the control unit 50. The operation and operating mode of the vibration power device 710 may be controlled by the control unit 50.

The vibration power device 710 is coupled to the receiving conveyor 400 by the vibration frame 720. In this case, the vibration power device 710 may be arranged in contact with the vibration belt member 410.

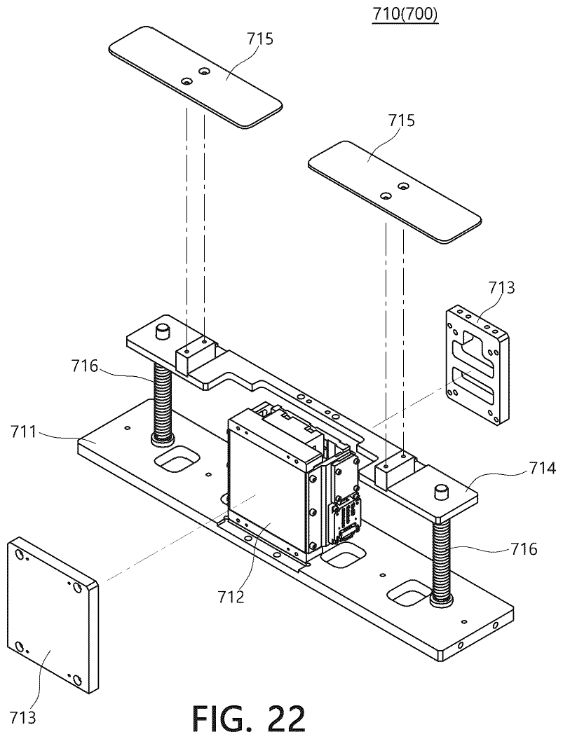

In the embodiment illustrated in FIG. 22, the vibration power device 710 includes a support plate 711, a vibration generating device 712, a protection block 713, a protection plate 714, an amplifying plate 715, and an elastic member 716.

The support plate 711 supports other components of the vibration power device 710. The support plate 711 is fixedly coupled to the vibration frame 720. In the illustrated embodiment, the support plate 711 supports the vibration generating device 712 and the elastic member 716. By means of the support plate 711, the vibration power device 710 is prevented from being unintentionally separated or displaced by the generated vibration (v).

The support plate 711 may have any shape capable of supporting other components of the vibration power device 710. In the illustrated embodiment, it is provided in the form of a plate having a length in the width direction of the receiving conveyor 400, specifically in the left-right direction, and a thickness in the vertical direction.

The vibration generating device 712 is operated by the control unit 50 to generate vibration (v). The generated vibration may be transmitted to the vibration belt member 410 via the protection plate 714 and the amplifying plate 715.

The vibration generating device 712 may be provided in any form capable of generating vibration (v). In one embodiment, the vibration generating device 712 may be implemented as a voice coil motor. In the above embodiment, the vibration generating device 712 is configured to vibrate in its height direction, that is, the vertical direction, and the intensity or distance of the vibration can be easily adjusted by controlling the vibration frequency.

The protection block 713 is arranged to surround the vibration generating device 712. The protection block 713 is configured to protect the vibration generating device 712. In the illustrated embodiment, the protection block 713 surrounds the vibration generating device 712 in the thickness direction, that is, the front-rear direction.

A plurality of protection blocks 713 may be provided. The plurality of protection blocks 713 may surround the vibration generating device 712 at different positions. In the illustrated embodiment, a pair of protection blocks 713 is provided to surround the vibration generating device 712 from the front side and the rear side, respectively. That is, the pair of protection blocks 713 is disposed to face each other with the vibration generating device 712 interposed therebetween.

The protection plate 714 is configured to support the load caused by the vibration belt member 410 or components seated on the vibration belt member 410, thereby preventing the load from being directly transmitted to the vibration generating device 712. In other words, the protection plate 714 protects the vibration generating device 712.

The protection plate 714 is coupled to the support plate 711. Specifically, the protection plate 714 is coupled to the support plate 711 by means of the elastic member 716. Accordingly, it can be said that the protection plate 714 is elastically supported by the support plate 711.

The protection plate 714 may have a shape corresponding to that of the support plate 711. In the illustrated embodiment, the protection plate 714 has a plate shape that extends in the width direction of the support plate 711, that is, the left-right direction, and has a thickness in the vertical direction.

In this case, the protection plate 714 is coupled to one of the plurality of protection blocks 713 and may receive the vibration generated by the vibration generating device 712 coupled to that protection block 713. In the illustrated embodiment, the protection plate 714 is coupled to the upper side of one of the protection blocks 713 located at the rear side and may receive the generated vibration.

The vibration transmitted from the protection block 713 may be delivered to the amplifying plate 715 via the protection plate 714.

Accordingly, while preventing damage to the vibration generating device 712 due to external force, the vibration (v) generated by the vibration generating device 712 can be transmitted to the vibration belt member 410 with minimal loss.

The protection plate 714 is coupled to the amplifying plate 715.

The amplifying plate 715 transmits the vibration (v) generated by the vibration generating device 712 to the vibration belt member 410. The amplifying plate 715 is coupled to the protection plate 714, but only a relatively small area of the amplifying plate 715 is coupled to the protection plate 714 compared to its total area. Accordingly, when the vibration generating device 712 is operated, the vibration (v) of the amplifying plate 715 can be amplified and transmitted to the vibration belt member 410.

The amplifying plate 715 may be provided in any form capable of amplifying vibration (v) and transmitting it to the vibration belt member 410. In the illustrated embodiment, the amplifying plate 715 is provided in the form of a plate having a length in the left-right direction and a width in the vertical direction.

A plurality of amplifying plates 715 may be provided. The plurality of amplifying plates 715 may be coupled to the protection plate 714 at different positions and may be brought into contact with the vibration belt member 410. In the illustrated embodiment, a pair of amplifying plates 715 is provided and spaced apart in the longitudinal direction of the protection plate 714, that is, the left-right direction.

The elastic member 716 elastically couples the protection plate 714 and the amplifying plate 715 to the support plate 711. The elastic member 716 is respectively coupled to the support plate 711, the protection plate 714, and the amplifying plate 715.

With the provision of the elastic member 716, the load caused by the vibration belt member 410 or components seated on the vibration belt member 410 can be buffered or offset by the elastic member 716. Accordingly, damage to the vibration generating device 712 caused by such a load can be prevented.

The elastic member 716 extends in the height direction of the vibration transfer member 700, specifically in the vertical direction in the illustrated embodiment. One end of the elastic member 716 in the longitudinal direction, specifically the lower end in the illustrated embodiment, is coupled to the support plate 711. The other end of the elastic member 716 in the longitudinal direction, specifically the upper end in the illustrated embodiment, is coupled to the protection plate 714 and the amplifying plate 715.

The elastic member 716 may be provided in any form capable of buffering the above-mentioned load. In the illustrated embodiment, the elastic member 716 may be provided in the form of a coil spring.

A plurality of elastic members 716 may be provided. The plurality of elastic members 716 may be spaced apart in the longitudinal direction of the support plate 711, specifically in the left-right direction in the illustrated embodiment. In the illustrated embodiment, a pair of elastic members 716 is provided and spaced apart in the left-right direction. The pair of elastic members 716 is arranged to face each other with the vibration generating device 712 interposed therebetween.

The vibration frame 720 couples the vibration power device 710 to the receiving conveyor 400. The vibration frame 720 is respectively coupled to the vibration power device 710 and the receiving conveyor 400.

Although no reference numeral is assigned, the vibration frame 720 may include a housing. A space may be formed inside the housing to accommodate the vibration power device 710. The housing may be fixedly coupled to the receiving conveyor 400.

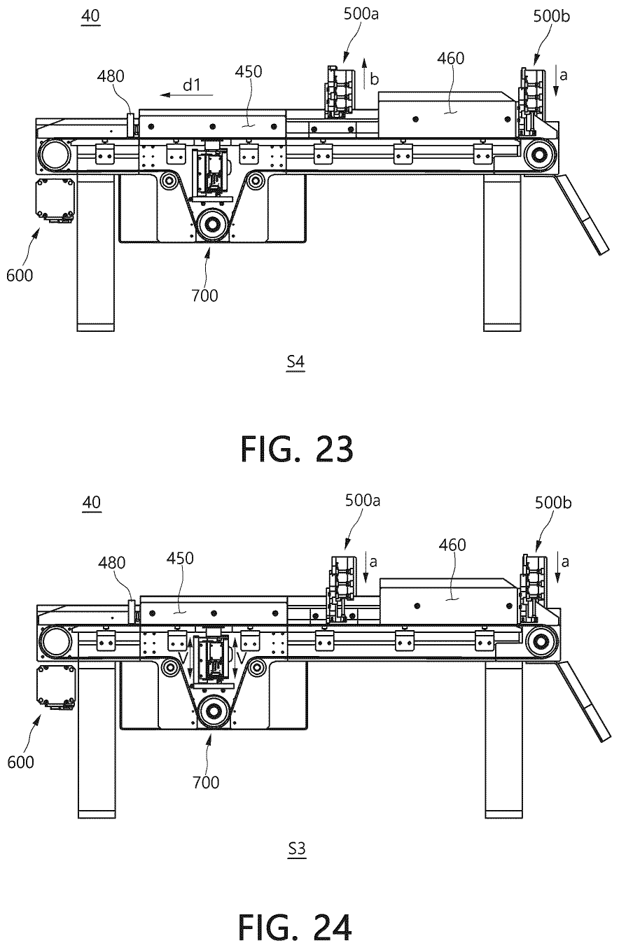

Referring to FIGS. 23 to 25, a process is illustrated in which vibration (v) is applied to the components accommodated in the component collection unit 40, thereby causing the components to be rearranged.

Referring to FIG. 23, the first stopper member 500a is raised, allowing fluid communication between the collection space 450 and the discharge space 460. When the collection power device 600 is operated, the vibration belt member 410 moves in a first direction (d1), and the components accommodated in the discharge space 460 can be moved into the collection space 450.

Referring to FIG. 24, the first stopper member 500a is lowered, blocking fluid communication between the collection space 450 and the discharge space 460. When the vibration transfer member 700 is operated and vibration (v) is applied to the collection space 450, the vibration belt member 410 and the components seated thereon are vibrated, causing the components to be rearranged.

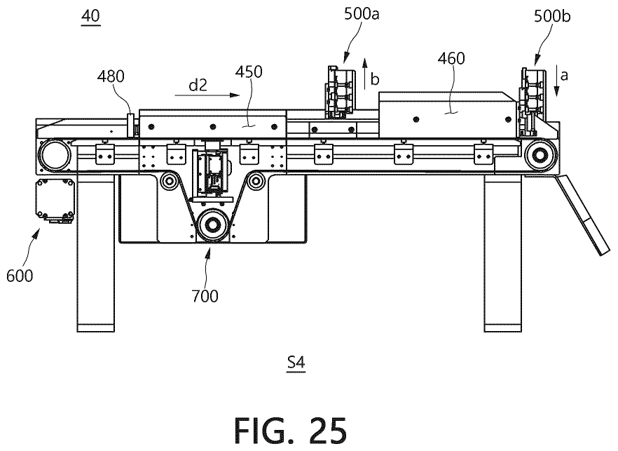

Referring to FIG. 25, the first stopper member 500a is raised, allowing fluid communication between the collection space 450 and the discharge space 460. When the collection power device 600 is operated, the vibration belt member 410 moves in a second direction (d2), and the components accommodated in the collection space 450 can be moved into the discharge space 460.

The above-described process is based on the premise that the components accommodated in the discharge space 460 are transferred to the collection space 450 and then rearranged by vibration (v). Alternatively, it will be understood that the collection space 450 and the discharge space 460 may remain in a state of blocked fluid communication (i.e., with the first stopper member 500a in the lowered state), and vibration (v) may be applied to the components already accommodated in the collection space 450 to rearrange them.

In addition, in the above process, it will be understood that the second stopper member 500b remains in the lowered state, thereby blocking fluid communication between the discharge space 460 and the outside. Accordingly, unintentional discharge of components through the discharge space 460 can be prevented.

Referring to FIG. 29, the smart feeding system 1 according to an embodiment of the present disclosure further includes a control unit 50.

The control unit 50 is electrically connected to the component supply unit 10, the input adjusting unit 20, the component transfer unit 30, and the component collection unit 40, respectively. The control unit 50 may receive detection information generated from the component supply unit 10, the input adjusting unit 20, the component transfer unit 30, and the component collection unit 40, and compute information regarding the operational status of the smart feeding system 1.

In addition, the control unit 50 may compute control information for controlling the component supply unit 10, the input adjusting unit 20, the component transfer unit 30, and the component collection unit 40 based on the computed information, and control each unit based on the computed control information.

The control unit 50 may be provided in any form capable of inputting, computing, and outputting information. In one embodiment, the control unit 50 may be implemented as an electronic device including a microprocessor, a CPU, or the like.

In the illustrated embodiment, the control unit 50 includes an information computation unit 800 and a power device control unit 900.

The information computation unit 800 receives detection information generated by each detection device 230 and 490 and computes information regarding the operational status of the smart feeding system 1. The computed information is delivered to the power device control unit 900 and may be used to control the respective power devices 160, 250, 600, and 710. The information computation unit 800 is electrically connected to each detection device 230 and 490 and the power device control unit 900.

As described above, in one embodiment, the information computation unit 800 may further use detection information generated by the supply component detection device 170 to compute information regarding the operational status of the smart feeding system 1.

In the illustrated embodiment, the information computation unit 800 includes a product information input module 810, a component information computation module 820, a supply information computation module 830, a remaining information computation module 840, a collection information computation module 850, a vibration information computation module 860, a movement information computation module 870, and a discharge information computation module 880.

The product information input module 810 receives product information regarding the product for which the components are to be supplied. The product information input module 810 may be implemented in the form of a terminal and may receive the product information either from an operator or by being extracted from a predetermined process.

The product information received by the product information input module 810 is delivered to the component information computation module 820 and is used to compute component information regarding the components to be supplied by the smart feeding system 1.

The product information may include any information related to the product to be manufactured, including the components. In one embodiment, the product information may include product specification information and product quantity information. The product specification information may be defined as information related to the specifications of the product. The product quantity information may be defined as information related to the quantity of the product.

That is, when product information is input, it can be determined whether a specific quantity of components having a specific specification should be supplied. Accordingly, it will be understood that if product information is continuously input, the supply of components by the smart feeding system 1 can also be performed continuously.

To this end, in the illustrated embodiment, the product information input module 810 includes a product specification information input unit 811 and a product quantity information input unit 812.

The product specification information input unit 811 receives product specification information. The product specification information input unit 811 may transmit the received product specification information to the component information computation module 820. The product specification information input unit 811 is electrically connected to the component information computation module 820.

The product quantity information input unit 812 receives product quantity information. The product quantity information input unit 812 may transmit the received product quantity information to the component information computation module 820. The product quantity information input unit 812 is electrically connected to the component information computation module 820.

The component information computation module 820 computes component information, which refers to information about the components to be supplied to the outside. The component information computation module 820 may compute the component information using the product information input through the product information input module 810. The component information computation module 820 is electrically connected to the product information input module 810.

The component information computed by the component information computation module 820 may include any information regarding the components to be supplied to the outside by the smart feeding system 1. In one embodiment, the component information may include component specification information and component quantity information.

The component specification information may be defined as information regarding the specifications of the components to be supplied. The component specification information may be used to distinguish between different components.

The component quantity information may be defined as information regarding the quantity of components to be supplied. The component quantity information may be used to compute the quantity of components to be supplied for a specific product.

Accordingly, as the component specification information and component quantity information are computed, it can be determined which components and in what quantity should be supplied.

To this end, in the illustrated embodiment, the component information computation module 820 includes a component specification information computation unit 821 and a component quantity information computation unit 822.

The component specification information computation unit 821 computes component specification information using the product specification information. The component specification information computation unit 821 is electrically connected to the product specification information input unit 811.

The component specification information computed by the component specification information computation unit 821 may include any information related to the specifications of the components to be supplied to the outside by the smart feeding system 1. In one embodiment, the component specification information may include information related to the material, size, weight, electrical conductivity, or the like of the components.

The component quantity information computation unit 822 computes component quantity information using the product quantity information. The component quantity information computation unit 822 is electrically connected to the product quantity information input unit 812.

The supply information computation module 830 computes supply information using the computed component information. The supply information computation module 830 is electrically connected to the component information computation module 820.

The supply information may be defined as information used for specifying the components to be supplied by the component supply unit 10. As described above, the component supply unit 10 may include a plurality of component supply sub-units, such as the first to fourth component supply units 11, 12, 13, and 14. In this case, different components may be accommodated in the first to fourth component supply units 11, 12, 13, and 14.

Accordingly, the supply information computed by the supply information computation module 830 may be defined as information for determining which component supply unit (11, 12, 13, or 14) should supply what quantity of components to the input adjusting unit 20.

The supply information may include any information that specifies at least one of the plurality of component supply units (11, 12, 13, and 14) and indicates how many components are to be withdrawn from the specified component supply unit(s) (11, 12, 13, and 14). In one embodiment, the supply information may include supply specification information and supply quantity information.

The supply specification information may be defined as information for specifying at least one of the plurality of component supply units (11, 12, 13, and 14). The supply quantity information may be defined as information regarding the quantity of components to be withdrawn from the specified one or more component supply units.

Accordingly, when the supply information is computed, the components to be withdrawn from the component supply unit 10 can be specified.

To this end, in the illustrated embodiment, the supply information computation module 830 includes a supply specification information computation unit 831 and a supply quantity information computation unit 832.

The supply specification information computation unit 831 computes supply specification information using the component specification information. The supply specification information computation unit 831 is electrically connected to the component specification information computation unit 821.

The supply specification information computed by the supply specification information computation unit 831 may be delivered to the power device control unit 900 and used to compute control information for controlling the supply power device 160. The supply specification information computation unit 831 is electrically connected to the power device control unit 900.

The supply quantity information computation unit 832 computes supply quantity information using the component quantity information. The supply quantity information computation unit 832 is electrically connected to the component quantity information computation unit 822.

The supply quantity information computed by the supply quantity information computation unit 832 may be delivered to the power device control unit 900 and used to compute control information for controlling the supply power device 160. The supply quantity information computation unit 832 is electrically connected to the power device control unit 900.

The remaining information computation module 840 computes remaining information regarding the quantity of components accommodated in the tray space 214 of the tray member 210. The remaining information computation module 840 may compute the remaining information using detection information generated by the remaining component detection device 230. The remaining information computation module 840 is electrically connected to the remaining component detection device 230.

The remaining information computed by the remaining information computation module 840 may be delivered to the supply power device control module 910 of the power device control unit 900. The supply power device control module 910 may compute control information for controlling the supply power device 160 using the computed remaining information. The remaining information computation module 840 is electrically connected to the supply power device control module 910.

In the illustrated embodiment, when the computed remaining information indicates that a sufficient or excessive amount of components remains in the tray member 210, the supply power device control module 910 may compute control information to stop the additional supply of components from the component supply unit 10. That is, the supply power device control module 910 controls the supply power device 160 so that the operation of the supply power device 160 is stopped.

In addition, the remaining information computed by the remaining information computation module 840 may be delivered to an input power device control module 920 of the power device control unit 900. The input power device control module 920 may compute control information for controlling the input power device 250 using the computed remaining information. The remaining information computation module 840 is electrically connected to the input power device control module 920.

In the illustrated embodiment, when the computed remaining information indicates that a sufficient or excessive amount of components remain in the tray member 210, the input power device control module 920 may compute control information such that the second tray surface 212 moves toward the component supply unit 10. That is, the input power device control module 920 may compute control information for controlling the input power device 250 so that the components received in the tray member 210 are transferred to the component transfer unit 30.

The collection information computation module 850 computes collection information related to the components collected in the collection space 450. The collection information computation module 850 may compute the collection information using detection information generated by the collected component detection device 490. The collection information computation module 850 is electrically connected to the collected component detection device 490.

The collection information may include arbitrary information related to the components residing in the collection space 450. In one embodiment, the collection information may include collection specification information, collection quantity information, and collection state information.

The collection specification information may be defined as information on the specifications of the components residing in the collection space 450. The collection specification information may be delivered to the discharge information computation module 880 and used for computing discharge information.

The collection quantity information may be defined as information on the quantity of components residing in the collection space 450. The collection quantity information may be delivered to the power device control unit 900 and used for computing control information for supplying additional components from the component supply unit 10.

The collection state information may be defined as information on the position, orientation, or arrangement of the components residing in the collection space 450. The collection state information may be delivered to the power device control unit 900 and used for computing control information for changing the arrangement state of the components collected in the collection space 450.

To this end, in the illustrated embodiment, the collection information computation module 850 includes a collection specification information computation unit 851, a collection quantity information computation unit 852, and a collection state information computation unit 853.

The collection specification information computation unit 851 computes collection specification information using detection information generated by the collected component detection device 490. The collection specification information computed by the collection specification information computation unit 851 is delivered to the discharge information computation module 880 and used for computing discharge information on whether to discharge the components collected in the collection space 450. The collection specification information computation unit 851 is electrically connected to the discharge information computation module 880.

The collection quantity information computation unit 852 computes collection quantity information using detection information generated by the collected component detection device 490. The collection quantity information computed by the collection quantity information computation unit 852 is delivered to a supply power device control module 910, an input power device control module 920, a transfer power device control module 930, a blocking power device control module 940, and a collection power device control module 950 and used for computing control information for supplying additional components. The collection quantity information computation unit 852 is electrically connected to each of the control modules 910, 920, 930, 940, and 950.

In one embodiment, the collection quantity information computation unit 852 may be electrically connected to the movement information computation module 870. In the above embodiment, the movement information computation module 870 may compute movement information for operating the collection power device 600 using the computed collection quantity information.

The collection state information computation unit 853 computes collection state information using detection information generated by the collected component detection device 490. The collection state information computed by the collection state information computation unit 853 is delivered to the vibration information computation module 860 and used for computing vibration information regarding whether to apply vibration to the components collected in the collection space 450. The collection state information computation unit 853 is electrically connected to the vibration information computation module 860.

In one embodiment, the collection state information computation unit 853 may be directly and electrically connected to the vibration power device control module 960. In the above embodiment, the vibration power device control module 960 may directly compute control information for controlling the vibration power device 710 using the collection state information.

The vibration information computation module 860 computes vibration information using the collection state information computed by the collection state information computation unit 853. The vibration information may be defined as information on whether to apply vibration to the components collected in the collection space 450 to change their positions, orientations, arrangement states, and the like. The vibration information computation module 860 is electrically connected to the collection state information computation unit 853.

The vibration information computed by the vibration information computation module 860 may include various types of information related to the operation of the vibration power device 710. For example, the vibration information may include information related to the intensity, duration, application cycle, and the like of the vibration applied by the vibration power device 710 to the components collected in the collection space 450.

The vibration information computed by the vibration information computation module 860 is delivered to the vibration power device control module 960. The vibration information computation module 860 is electrically connected to the vibration power device control module 960.

The movement information computation module 870 computes movement information using the collection quantity information computed by the collection quantity information computation unit 852. In addition, the movement information computation module 870 computes movement information using the discharge information computed by the discharge information computation module 880. The movement information computation module 870 is electrically connected to the collection quantity information computation unit 852 and the discharge information computation module 880, respectively.

The movement information may be defined as information for moving the components located in the collection space 450 or the discharge space 460 by moving the vibration belt member 410 that surrounds the collection space 450 and the discharge space 460 from below. That is, the movement information may be defined as information related to the operation of the collection power device 600 that moves the vibration belt member 410.

The movement information may include information of any form related to the operation of the collection power device 600. In one embodiment, the movement information may include information related to the rotation direction and rotation angle of the collection power device 600. In an embodiment in which the collection power device 600 is implemented as a servo motor, the movement information may include information for stopping the collection power device 600 after rotating by a preset angle in one direction and then stopping again after rotating by a preset angle in the other direction.

The movement information computed by the movement information computation module 870 is delivered to the collection power device control module 950. The movement information computation module 870 and the collection power device control module 950 are electrically connected.

The discharge information computation module 880 computes discharge information regarding whether the components located in the collection space 450 are to be discharged to the outside. The discharge information computation module 880 may compute the discharge information using the component specification information and the collection specification information. The discharge information computation module 880 is electrically connected to the component specification information computation unit 821 and the collection specification information computation unit 851.

When the computed component specification information and collection specification information are identical, it may be determined that the components collected in the collection space 450 can continue to be supplied to the outside. Accordingly, the discharge information computation module 880 computes discharge information such that the components collected in the collection space 450 are not discharged.

On the other hand, when the computed component specification information and collection specification information are different, it may be determined that the components collected in the collection space 450 need to be removed. Accordingly, the discharge information computation module 880 computes discharge information such that the components collected in the collection space 450 are discharged.

The discharge information computed by the discharge information computation module 880 is delivered to the power device control unit 900 and then to each of the control modules 910, 920, 930, 940, and 950, which control the respective components that need to be operated to discharge the components collected in the collection space 450. The discharge information computation module 880 is electrically connected to each of the control modules 910, 920, 930, 940, and 950.

The power device control unit 900 computes control information for controlling the power devices 160, 250, 320, 490, 520, 600, and 710 based on the information computed by the information computation unit 800. The power device control unit 900 may control the power devices 160, 250, 320, 490, 520, 600, and 700 based on the computed control information. The power device control unit 900 is electrically connected to the power devices 160, 250, 320, 490, 520, 600, and 700 and to the information computation unit 800, respectively.

In the illustrated embodiment, the power device control unit 900 includes a supply power device control module 910, an input power device control module 920, a transfer power device control module 930, a blocking power device control module 940, a collection power device control module 950, and a vibration power device control module 960.

The supply power device control module 910 computes control information for controlling the supply power device 160 using the computed supply information. The supply power device control module 910 is electrically connected to the supply information computation module 830.

Specifically, the supply power device control module 910 may compute at least one of the component supply units 10 corresponding to the computed supply specification information among the plurality of component supply units 11, 12, 13, and 14.

In addition, the supply power device control module 910 may compute control information for controlling the supply power device 160 provided in the one or more component supply units 10 so that components corresponding to the computed supply quantity information are supplied.

In addition, the supply power device control module 910 controls the supply power device 160 using the computed remaining information. The supply power device control module 910 is electrically connected to the remaining information computation module 840.

Specifically, the supply power device control module 910 may compute control information by comparing the computed remaining information with preset reference remaining information.

If the computed remaining information is equal to or greater than the reference remaining information, it may be understood that a sufficient quantity of components is secured in the tray member 210. Accordingly, the supply power device control module 910 computes control information to stop the supply power device 160 so as to suspend the supply of additional components.

On the other hand, if the computed remaining information is less than the reference remaining information, it may be understood that additional components need to be supplied. Accordingly, the supply power device control module 910 computes control information to operate the supply power device 160 so that additional components are supplied.

In the above embodiment, the reference remaining information may be defined as information on the quantity of components accommodated in the tray member 210 when the components are neither excessive nor insufficient.

Furthermore, the supply power device control module 910 controls the supply power device 160 using the computed discharge information. The supply power device control module 910 is electrically connected to the discharge information computation module 880.

When the computed discharge information indicates a situation where the components collected in the collection space 450 need to be discharged—i.e., removal is necessary-additional supply of components must be halted. Accordingly, the supply power device control module 910 computes control information to stop the supply power device 160 so as to suspend the additional supply of components.

When the computed discharge information indicates that discharging the components collected in the collection space 450 is unnecessary, it may be understood that additional supply of components is required. Accordingly, the supply power device control module 910 computes control information to operate the supply power device 160 so as to supply additional components.

The supply power device control module 910 may control the supply power device 160 based on the computed control information. The supply power device control module 910 is electrically connected to the supply power device 160.

The input power device control module 920 computes control information for controlling the input power device 250 using the computed remaining information. The input power device control module 920 is electrically connected to the remaining information computation module 840.

Specifically, if the computed remaining information is equal to or greater than the reference remaining information, it may be understood that the components accommodated in the tray member 210 need to be transferred to the component transfer unit 30. Accordingly, the input power device control module 920 computes control information for controlling the input power device 250 coupled to the second tray surface 212 so that the lower side of the tray space 214 is opened.

On the other hand, if the computed remaining information is less than the reference remaining information, it may be understood that additional components need to be supplemented in the tray member 210. Accordingly, the input power device control module 920 computes control information for controlling the input power device 250 coupled to the second tray surface 212 so that the lower side of the tray space 214 is closed.

In addition, the input power device control module 920 computes control information for controlling the input power device 250 using the computed collection information. The input power device control module 920 is electrically connected to the collection information computation module 850.

Specifically, if the computed collection quantity information is equal to or greater than preset reference quantity information, it may be understood as a situation in which the additional supply of components to the collection space 450 should be stopped. Accordingly, the input power device control module 920 computes control information for controlling the input power device 250 coupled to the second tray surface 212 so that the lower side of the tray space 214 is closed.

In addition, if the computed collection quantity information is less than the reference quantity information, it may be understood as a situation in which additional components need to be supplied to the collection space 450. Accordingly, the input power device control module 920 computes control information for controlling the input power device 250 coupled to the second tray surface 212 so that the lower side of the tray space 214 is opened.

Furthermore, the input power device control module 920 may compute control information for controlling the input power device 250 using the computed discharge information. The input power device control module 920 is electrically connected to the discharge information computation module 880.

Specifically, when the computed discharge information indicates that the components collected in the collection space 450 need to be removed, it may be understood as a situation in which the supply of additional components to the collection space 450 should be stopped. Accordingly, the input power device control module 920 computes control information for controlling the input power device 250 coupled to the second tray surface 212 so that the lower side of the tray space 214 is closed.

In addition, when the computed discharge information indicates that the removal of the components collected in the collection space 450 is unnecessary, it may be understood as a situation in which the supply of additional components to the collection space 450 is required. Accordingly, the input power device control module 920 computes control information for controlling the input power device 250 coupled to the second tray surface 212 so that the lower side of the tray space 214 is opened.

The input power device control module 920 may control the input power device 250 based on the computed control information. The input power device control module 920 is electrically connected to the input power device 250.

The transfer power device control module 930 computes control information for controlling the transfer power device 320 using the computed remaining information. The transfer power device control module 930 is electrically connected to the remaining information computation module 840.

Specifically, if the computed remaining information is equal to or greater than the reference remaining information, it may be understood that the components accommodated in the tray member 210 should be delivered to the component collection unit 40 through the component transfer unit 30. Accordingly, the transfer power device control module 930 computes control information for controlling the transfer power device 320 so that the components seated on the belt member 310 are delivered to the receiving conveyor 400.

In addition, if the computed remaining information is less than the reference remaining information, it may be understood that additional components should first be provided to the tray member 210. Accordingly, the transfer power device control module 930 computes control information for controlling the transfer power device 320 so that the components seated on the belt member 310 are not delivered to the receiving conveyor 400.

The transfer power device control module 930 computes control information for controlling the transfer power device 320 using the computed collection information. The transfer power device control module 930 is electrically connected to the collection information computation module 850.

Specifically, if the computed collection quantity information is equal to or greater than preset reference quantity information, it may be understood as a situation in which the additional supply of components to the collection space 450 should be stopped. Accordingly, the transfer power device control module 930 computes control information for controlling the transfer power device 320 so that the components seated on the belt member 310 are delivered to the receiving conveyor 400.

In addition, if the computed collection quantity information is less than the reference quantity information, it may be understood as a situation in which additional components need to be supplied to the collection space 450. Accordingly, the transfer power device control module 930 computes control information for controlling the transfer power device 320 so that the components seated on the belt member 310 are not delivered to the receiving conveyor 400.

The transfer power device control module 930 computes control information for controlling the transfer power device 320 using the computed discharge information. The transfer power device control module 930 is electrically connected to the discharge information computation module 880.

Specifically, when the computed discharge information indicates that the components collected in the collection space 450 need to be removed, it may be understood as a situation in which the supply of additional components to the collection space 450 should be stopped. Accordingly, the transfer power device control module 930 computes control information for controlling the transfer power device 320 so that the components seated on the belt member 310 are not delivered to the receiving conveyor 400.

In addition, when the computed discharge information indicates that the removal of the components collected in the collection space 450 is unnecessary, it may be understood as a situation in which the supply of additional components to the collection space 450 is required. Accordingly, the transfer power device control module 930 computes control information for controlling the transfer power device 320 so that the components seated on the belt member 310 are delivered to the receiving conveyor 400.

The transfer power device control module 930 may control the transfer power device 320 based on the computed control information. The transfer power device control module 930 is electrically connected to the transfer power device 320.

The blocking power device control module 940 computes control information for controlling the blocking power device 520. As described above, the blocking power device 520 may be respectively provided in the first stopper member 500a and the second stopper member 500b. Accordingly, the blocking power device control module 940 may include a first blocking power device control module 941 for controlling the blocking power device 520 of the first stopper member 500a, and a second blocking power device control module 942 for controlling the blocking power device 520 of the second stopper member 500b.

The blocking power device control module 940 computes control information for controlling the blocking power device 520 based on the computed collection information. The blocking power device control module 940 is electrically connected to the collection information computation module 850.

If the computed collection quantity information is equal to or greater than the reference quantity information, it may be understood that no additional components need to be supplied to the collection space 450. Accordingly, the first and second blocking power device control modules 941 and 942 compute control information so that the blocking power devices 520 of the first and second stopper members 500a and 500b lower the blocking plates 510 to partition the collection space 450 from the discharge space 460.

If the computed collection quantity information is less than the reference quantity information, it may be understood that additional components need to be supplied to the collection space 450. Accordingly, the first blocking power device control module 941 computes control information so that the blocking power device 520 of the first stopper member 500a raises the blocking plate 510 to provide fluid communication between the collection space 450 and the discharge space 460. In this case, the second blocking power device control module 942 computes control information so that the blocking power device 520 of the second stopper member 500b lowers the blocking plate 510 to block fluid communication between the discharge space 460 and the outside.

The blocking power device control module 940 computes control information for controlling the blocking power device 520 based on the computed vibration information. The blocking power device control module 940 is electrically connected to the vibration information computation module 860.

Specifically, when the computed vibration information indicates that the components collected in the collection space 450 need to be rearranged, it may be understood that fluid communication between the collection space 450 and the discharge space 460 should be blocked. Accordingly, the first and second blocking power device control modules 941 and 942 compute control information so that the blocking power devices 520 of the first and second stopper members 500a and 500b lower the blocking plates 510 to partition the collection space 450 from the discharge space 460.

In addition, when the computed vibration information indicates that the rearrangement of the components collected in the collection space 450 is unnecessary, it is preferable to prevent mixing between the components respectively positioned in the collection space 450 and the discharge space 460. Accordingly, the first and second blocking power device control modules 941 and 942 compute control information so that the blocking power devices 520 of the first and second stopper members 500a and 500b lower the blocking plates 510 to partition the collection space 450 from the discharge space 460.

The blocking power device control module 940 computes control information for controlling the blocking power device based on the computed discharge information. The blocking power device control module 940 is electrically connected to the discharge information computation module 880.

Specifically, when the computed discharge information indicates that the components located in the collection space 450 or the discharge space 460 need to be removed, the collection space 450 and the discharge space 460 should be in fluid communication with each other. Accordingly, the first and second blocking power device control modules 941 and 942 compute control information so that the blocking power devices 520 of the first and second stopper members 500a and 500b lower the blocking plates 510 to partition the collection space 450 from the discharge space 460.

Accordingly, the first blocking power device control module 941 computes control information so that the blocking power device 520 of the first stopper member 500a raises the blocking plate 510 to provide fluid communication between the collection space 450 and the discharge space 460. In this case, the second blocking power device control module 942 computes control information so that the blocking power device 520 of the second stopper member 500b raises the blocking plate 510 to allow fluid communication between the discharge space 460 and the outside.

In addition, when the computed discharge information indicates that the removal of the components located in the collection space 450 or the discharge space 460 is unnecessary, the collection space 450 and the discharge space 460 should be separated from each other. Accordingly, the first and second blocking power device control modules 941 and 942 compute control information so that the blocking power devices 520 of the first and second stopper members 500a and 500b lower the blocking plates 510 to partition the collection space 450 from the discharge space 460.

The blocking power device control module 940 may control the blocking power device 520 based on the computed control information. The blocking power device control module 940 is electrically connected to the blocking power device 520.

The collection power device control module 950 computes control information for controlling the collection power device 600 using the computed movement information. The collection power device control module 950 is electrically connected to the movement information computation module 870.

When the computed movement information indicates that the components located in the discharge space 460 are to be moved to the collection space 450, the collection power device control module 950 computes control information so that the collection power device 600 moves a portion of the vibration belt member 410—surrounding the discharge space 460 from below—toward the collection space 450.

In addition, when the computed movement information indicates that the components located in the collection space 450 are to be discharged to the discharge space 460 or to the outside, the collection power device control module 950 computes control information so that the collection power device 600 moves a portion of the vibration belt member 410—surrounding the collection space 450 from below—toward the discharge space 460.

The collection power device control module 950 may control the collection power device 600 based on the computed control information. The collection power device control module 950 is electrically connected to the collection power device 600.

The vibration power device control module 960 computes control information for controlling the vibration power device 710 using the computed vibration information. The vibration power device control module 960 is electrically connected to the vibration information computation module 860.

Specifically, when the computed vibration information indicates that rearrangement of the components accommodated in the collection space 450 is necessary, the vibration power device control module 960 computes control information so that the vibration power device 710 applies an external force to the components collected in the collection space 450.

In addition, when the computed vibration information indicates that rearrangement of the components collected in the collection space 450 is unnecessary, the vibration power device control module 960 computes control information so that the vibration power device 710 is not operated.

The vibration power device control module 960 may control the vibration power device 710 based on the computed control information. The vibration power device control module 960 is electrically connected to the vibration power device 710.

In one embodiment, the vibration power device control module 960 may control the vibration power device 710 to apply vibrations at predetermined time intervals. In the above embodiment, the components accommodated in the collection space 450 may be periodically rearranged, allowing the collected component detection device 490 to accurately identify the components and supply them to the outside.

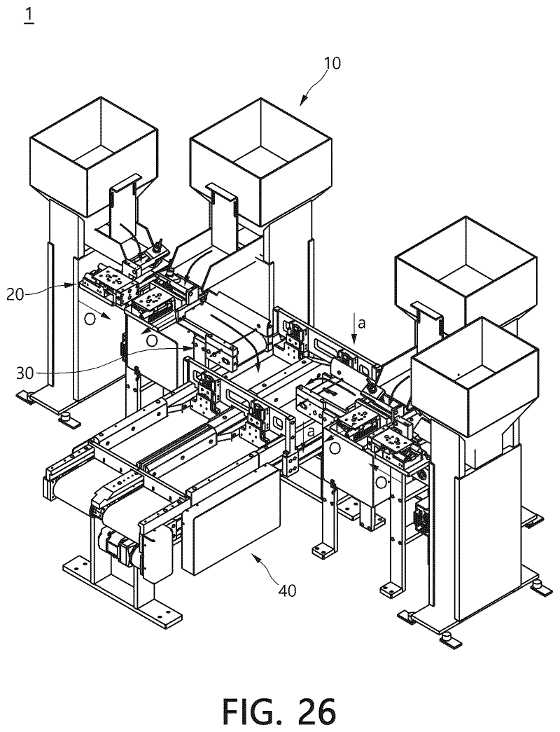

Referring to FIGS. 26 to 28, an example of the operation of the smart feeding system 1 according to an embodiment of the present disclosure is illustrated.

Referring to FIG. 26, a state in which components are supplied from the component supply unit 10 to the discharge space 460 is illustrated.

As described above, different components may be respectively supplied through the first to fourth component supply units 11, 12, 13, and 14. That is, the different components accommodated in the first to fourth component supply units 11, 12, 13, and 14 may be selectively supplied according to the process requirements.

Therefore, although FIG. 26 illustrates that components are simultaneously supplied from all of the first to fourth component supply units 11, 12, 13, and 14, this is for ease of understanding and explanation, and it will be understood that the supply of components by the first to fourth component supply units 11, 12, 13, and 14 may actually proceed independently of one another.

In this state, the component supply unit 10 operates to supply components to the input adjusting unit 20. The second tray surface 212 of the input adjusting unit 20 is moved in the opening direction O to be spaced apart from the first tray surface 211, so that the lower side of the tray space 214 is in fluid communication with the component transfer unit 30.

Furthermore, the transfer power device 320 of the component transfer unit 30 operates, allowing the components seated on the belt member 310 to be delivered to the discharge space 460 of the component collection unit 40.

In this case, the first stopper member 500a is lowered in direction (a), thereby blocking fluid communication between the collection space 450 and the discharge space 460. Accordingly, this state may be understood as the state immediately after the previously supplied components have been discharged in preparation for a change in the components to be supplied to the outside.

In addition, the second stopper member 500b is also lowered in direction (a), thereby blocking fluid communication between the discharge space 460 and the outside. Accordingly, it will be understood that the components delivered to the discharge space 460 are not discharged to the outside unintentionally.

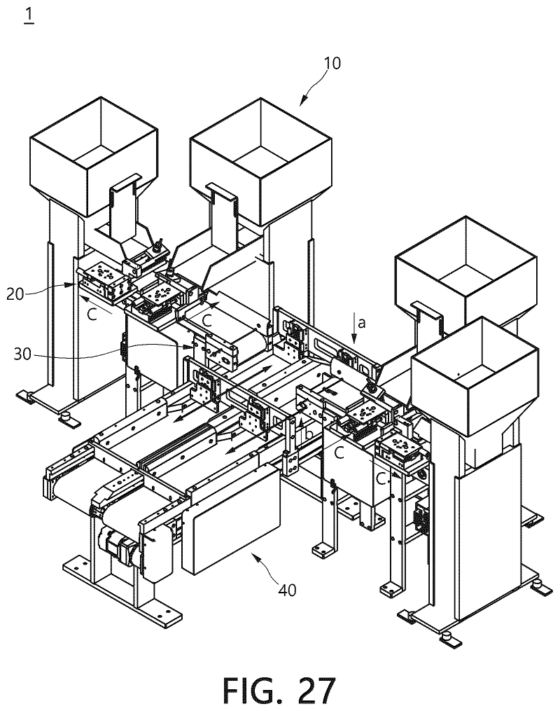

Referring to FIG. 27, a state is shown in which the supply of additional components has been stopped and fluid communication between the collection space 450 and the discharge space 460 is established. In this state, the operation of the component supply unit 10 is stopped, and the supply of components to the input adjusting unit 20 is stopped. The second tray surface 212 of the input adjusting unit 20 is moved in the closing direction (C) into contact with the first tray surface 211, thereby closing the lower side of the tray space 214.

Furthermore, the transfer power device 320 of the component transfer unit 30 is stopped, so that the components seated on the belt member 310 are not delivered to the discharge space 460 of the component collection unit 40.

At this time, the first stopper member 500a is raised in direction (b), establishing fluid communication between the collection space 450 and the discharge space 460. Accordingly, this state may be understood as a state in which a sufficient quantity of components has already been supplied and there is no need to change the components, thereby allowing the previously supplied components to be delivered to the outside.

In addition, the second stopper member 500b is lowered in direction (a), thereby blocking fluid communication between the discharge space 460 and the outside. Accordingly, it will be understood that the components delivered to the discharge space 460 are not discharged to the outside unintentionally.

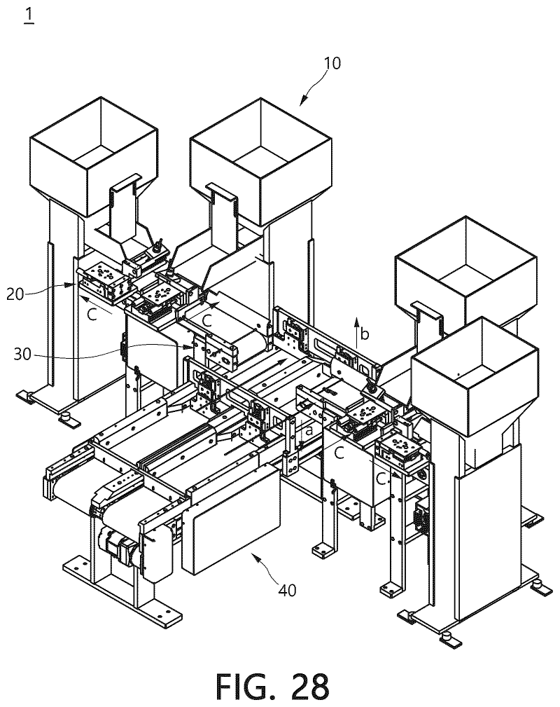

Referring to FIG. 28, a state is illustrated in which fluid communication between the collection space 450 and the discharge space 460 is blocked, and fluid communication between the discharge space 460 and the outside is established, while additional supply of components is stopped.

In this state, the operation of the component supply unit 10 is stopped, and the supply of components to the input adjusting unit 20 is stopped. The second tray surface 212 of the input adjusting unit 20 is moved in the closing direction (C) into contact with the first tray surface 211, thereby closing the lower side of the tray space 214.

Furthermore, the transfer power device 320 of the component transfer unit 30 is activated, so that all components seated on the belt member 310 may be delivered to the discharge space 460 of the component collection unit 40. Accordingly, the components previously supplied through the input adjusting unit 20, i.e., components to be discharged, may no longer remain in the component transfer unit 30.

In this case, the first stopper member 500a is lowered in direction (a), thereby blocking fluid communication between the collection space 450 and the discharge space 460. In addition, the second stopper member 500b is raised in direction (b), thereby establishing fluid communication between the discharge space 460 and the outside. Accordingly, the components delivered to the discharge space 460 may be discharged into the external bucket (B).

That is, the above state may be understood as a process for replacing the previously supplied components. In addition, it will be understood that, before the above state is established, two processes may be performed in advance: the transfer power device 320 may be activated so that the components seated on the belt member 310 are completely transferred to the discharge space 460, and the first stopper member 500a may be raised in direction (b) so that the components accommodated in the collection space 450 are moved into the discharge space 460.

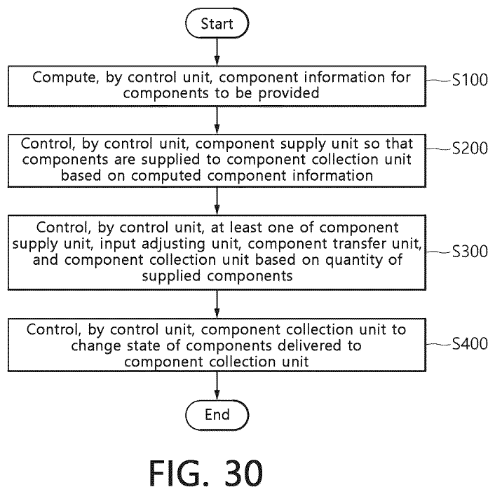

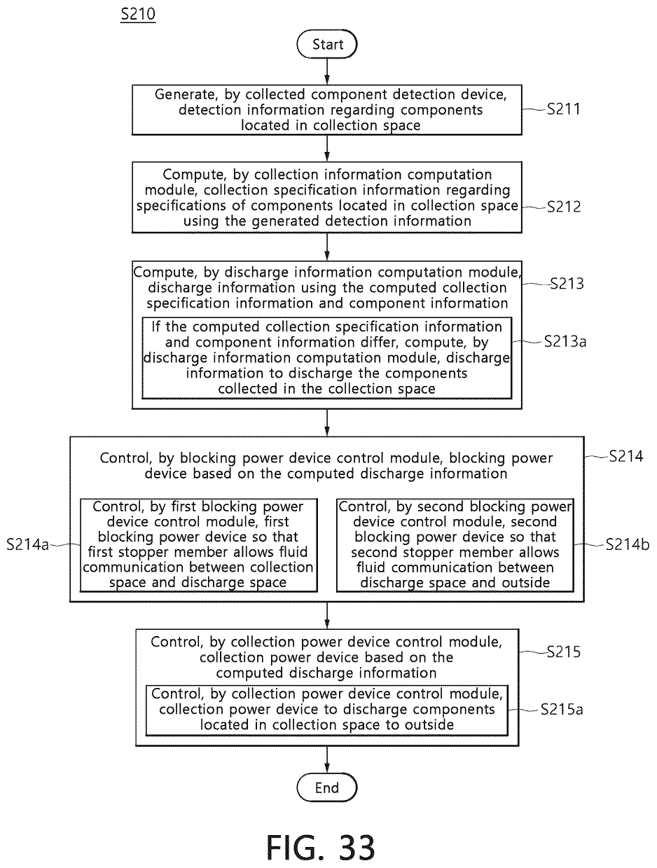

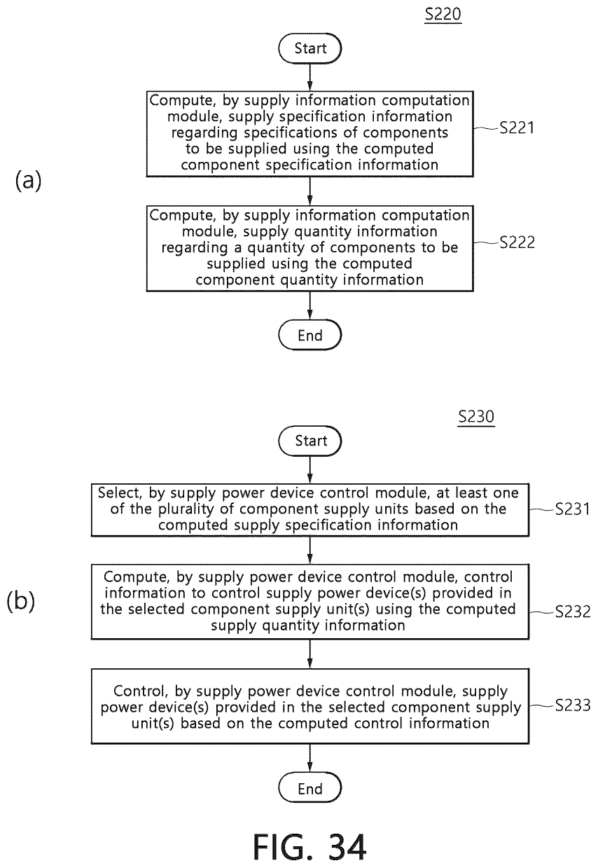

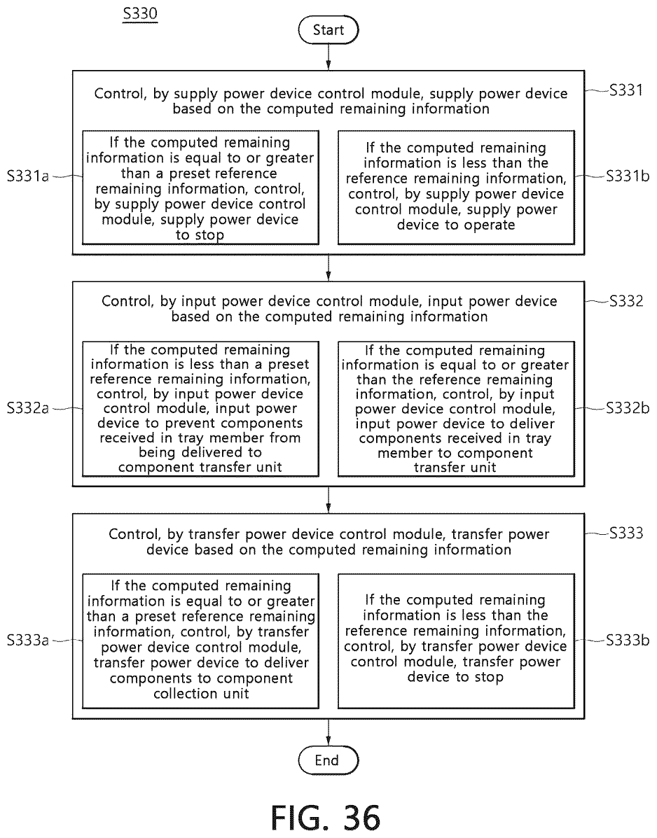

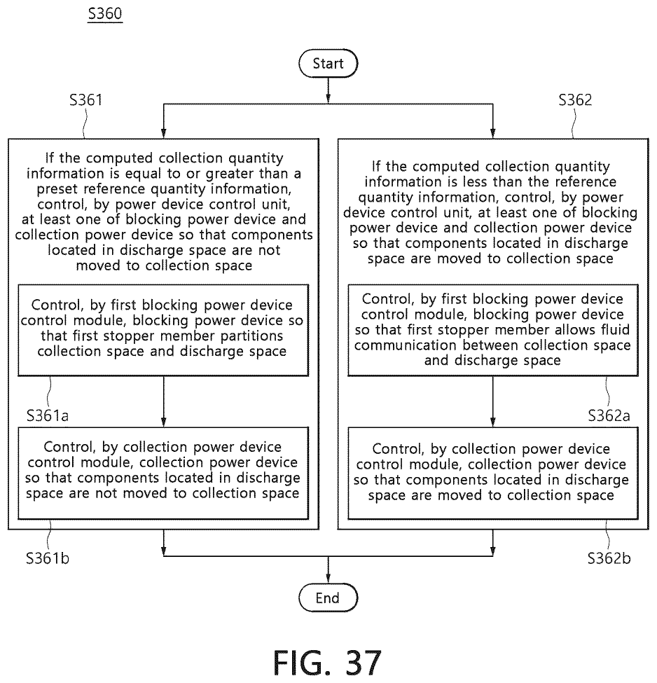

Referring to FIGS. 30 to 38, a control method of the smart feeding system 1 according to an embodiment of the present disclosure is illustrated. The control method of the smart feeding system 1 according to the illustrated embodiment may be performed by each component of the aforementioned smart feeding system 1.

In the illustrated embodiment, the control method of the smart feeding system 1 includes: a step S100 in which the control unit 50 computes component information for the components to be provided; a step S200 in which the control unit 50 controls the component supply unit 10 so that the components are supplied to the component collection unit 40 based on the computed component information; a step S300 in which the control unit 50 controls at least one of the component supply unit 10, the input adjusting unit 20, the component transfer unit 30, and the component collection unit 40 based on the quantity of the supplied components; and a step S400 in which the control unit 50 controls the component collection unit 40 to change the state of the components delivered to the component collection unit 40.

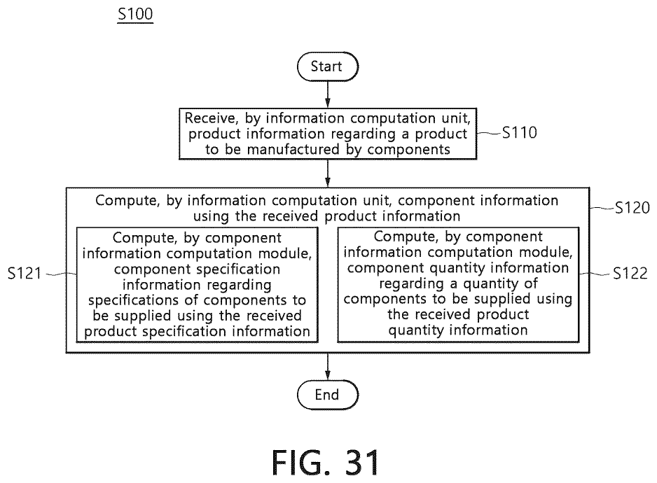

Referring to FIG. 31, a detailed flow of the step S100, in which the control unit 50 computes component information for the components to be supplied, is illustrated. The step S100 corresponds to a process where product information for a product to be manufactured is input and, based on the product information, the component information to be supplied is computed.

First, the product information input module 810 of the information computation unit 800 receives product information regarding the product to be manufactured using components (S110). The input product information may include product specification information and product quantity information.

The component information computation module 820 of the information computation unit 800 computes the component information based on the input product information (S120).

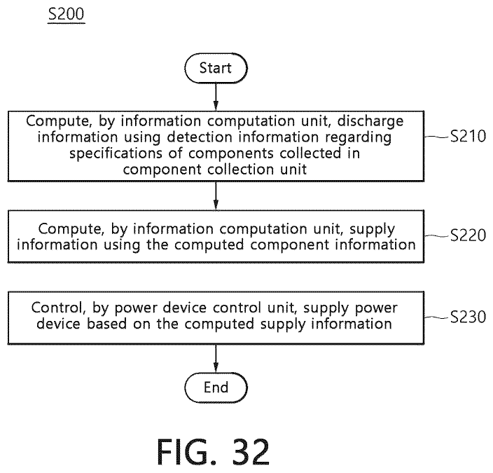

The step S120 may include a step S121 in which the component specification information computation unit 821 computes component specification information for the components to be supplied using the input product specification information, and a step S122 in which the component quantity information computation unit 822 computes component quantity information for the components to be supplied using the input product quantity information. Referring to FIGS. 32 to 34, a detailed flow of step S200, in which the control unit 50 controls the component supply unit 10 so that components are supplied to the component collection unit 40 based on the computed component information, is illustrated. The step S200 corresponds to a process in which the components to be supplied are selected based on the component information computed in step S100, and the selected components are delivered from the component supply unit 10 to the input adjusting unit 20.

The step S200 may be divided into a case in which the removal of the components located in the collection space 450 is required and a case in which it is not required. First, a case in which the removal of the components located in the collection space 450 is unnecessary will be described.

The supply information computation module 830 of the information computation unit 800 computes supply information using the computed component information (S220).

Specifically, the supply specification information computation unit 831 of the supply information computation module 830 computes supply specification information regarding the specifications of the components to be supplied using the computed component specification information (S221). In addition, the supply quantity information computation unit 832 of the supply information computation module 830 computes supply quantity information regarding the quantity of the components to be supplied using the computed component quantity information (S222).

Next, the supply power device control module 910 of the power device control unit 900 controls the supply power device 160 using the computed supply information (S230).

Specifically, the supply power device control module 910 selects at least one of the plurality of component supply units 10 based on the computed supply specification information (S231). In addition, the supply power device control module 910 computes control information for controlling the supply power device 160 provided in the selected one or more component supply units 10 (S232), and controls the supply power device 160 provided in the selected one or more component supply units 10 based on the computed control information (S233).

Next, a case in which the removal of components located in the collection space 450 is required will be described.

Before the supply information is computed in step S220, the discharge information computation module 880 of the information computation unit 800 computes discharge information using detection information regarding the specifications of the components collected in the collection space 450 of the component collection unit 40 (S210).

Specifically, the collected component detection device 490 generates detection information about the components located in the collection space 450 (S211). The collection specification information computation unit 851 of the collection information computation module 850 computes collection specification information regarding the specifications of the components located in the collection space 450 using the generated detection information (S212).

The discharge information computation module 880 computes discharge information using the computed collection specification information and the component specification information (S213). Specifically, when the computed collection specification information and the component specification information are different, the discharge information computation module 880 computes discharge information such that the components collected in the collection space 450 are discharged (S213a).

In addition, the blocking power device control module 940 controls the blocking power device 520 based on the computed discharge information (S214), and the collection power device control module 950 controls the collection power device 600 based on the computed discharge information (S215).

In this case, the first blocking power device control module 941 controls the blocking power device 520 such that the first stopper member 500a establishes fluid communication between the collection space 450 and the discharge space 460 (S214a), and the second blocking power device control module 942 controls the blocking power device 520 such that the second stopper member 500b establishes fluid communication between the discharge space 460 and the outside (S214b).

In addition, the collection power device control module 950 controls the collection power device 600 so that the components located in the collection space 450 are discharged to the outside (S215a). Accordingly, the components previously stored in the collection space 450 are discharged to the outside, and new components matching the component specification information can be supplied to the collection space 450.

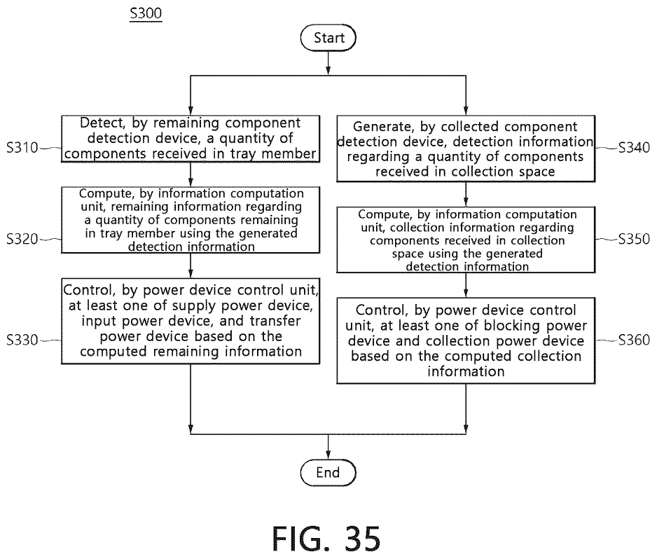

Referring to FIGS. 35 to 37, a detailed flow of step S300, in which the control unit 50 controls at least one of the component supply unit 10, the input adjusting unit 20, the component transfer unit 30, and the component collection unit 40 based on the quantity of components supplied, is illustrated. The step S300 is a process in which an appropriate quantity of components is delivered to the collection space 450 through the organic operation of the component supply unit 10, the input adjusting unit 20, the component transfer unit 30, and the component collection unit 40.

The step S300 may be divided into a step (S310, S320, S330) of transferring the components positioned in the input adjusting unit 20 and the component transfer unit 30 from the component supply unit 10 based on remaining information, and a step (S340, S350, S360) of transferring the components delivered to the component collection unit 40 based on collection information. The steps S310 to S360 may be performed simultaneously or concurrently.

First, the remaining component detection device 230 generates detection information on the quantity of components accommodated in the tray member 210 (S310). The remaining information computation module 840 of the information computation unit 800 computes remaining information on the quantity of components retained in the tray member 210 using the generated detection information (S320).

The power device control unit 900 controls at least one of the supply power device 160, the input power device 250, and the transfer power device 320 based on the computed remaining information (S330). The step S330 may be divided into a plurality of steps S331, S332, and S333 as follows:

First, the supply power device control module 910 controls the supply power device 160 based on the computed remaining information (S331).

Specifically, if the computed remaining information is equal to or greater than a preset reference remaining information, the supply power device control module 910 controls the supply power device 160 to stop its operation (S331a). In addition, if the computed remaining information is less than the reference remaining information, the supply power device control module 910 controls the supply power device 160 to operate (S331b).

In addition, the input power device control module 920 controls the input power device 250 based on the computed remaining information (S332).

Specifically, if the computed remaining information is less than the reference remaining information, the input power device control module 920 controls the input power device 250 so that the components accommodated in the tray member 210 are not transferred to the component transfer unit 30 (S332a). In addition, the computed remaining information is equal to or greater than the reference remaining information, the input power device control module 920 controls the input power device 250 so that the components accommodated in the tray member 210 are transferred to the component transfer unit 30 (S332b).

In addition, the transfer power device control module 930 controls the transfer power device 320 based on the computed remaining information (S333).

Specifically, if the computed remaining information is equal to or greater than the reference remaining information, the transfer power device control module 930 controls the transfer power device 320 so that the components are delivered to the component collection unit 40 (S333a). In addition, if the computed remaining information is less than the reference remaining information, the transfer power device control module 930 controls the transfer power device 320 so that the components are not delivered to the component collection unit 40 (S333b).

Meanwhile, the collected component detection device 490 generates detection information on the quantity of components accommodated in the collection space 450 (S340). The collection quantity information computation unit 852 of the collection information computation module 850 of the information computation unit 800 computes collection quantity information on the components accommodated in the collection space 450 using the generated detection information (S350). The power device control unit 900 controls at least one of the blocking power device 520 and the collection power device 600 based on the computed collection information (that is, collection quantity information) (S360).

Specifically, if the computed collection quantity information is equal to or greater than the preset reference quantity information, the power device control unit 900 controls at least one of the blocking power device 520 and the collection power device 600 so that the components positioned in the discharge space 460 are not moved to the collection space 450 (S361).

At this time, the first blocking power device control module 941 controls the blocking power device 520 provided in the first stopper member 500a so that the first stopper member 500a separates the collection space 450 and the discharge space 460 (S361a). In addition, the collection power device control module 950 controls the collection power device 600 so that the components positioned in the discharge space 460 are not moved to the collection space 450 (S361b).

In addition, if the computed collection quantity information is less than the reference quantity information, the power device control unit 900 controls at least one of the blocking power device 520 and the collection power device 600 so that the components positioned in the discharge space 460 are moved to the collection space 450 (S362).

At this time, the first blocking power device control module 941 controls the blocking power device 520 provided in the first stopper member 500a so that the first stopper member 500a establishes fluid communication between the collection space 450 and the discharge space 460 (S362a). In addition, the collection power device control module 950 controls the collection power device 600 so that the components positioned in the discharge space 460 are moved to the collection space 450 (S362b).

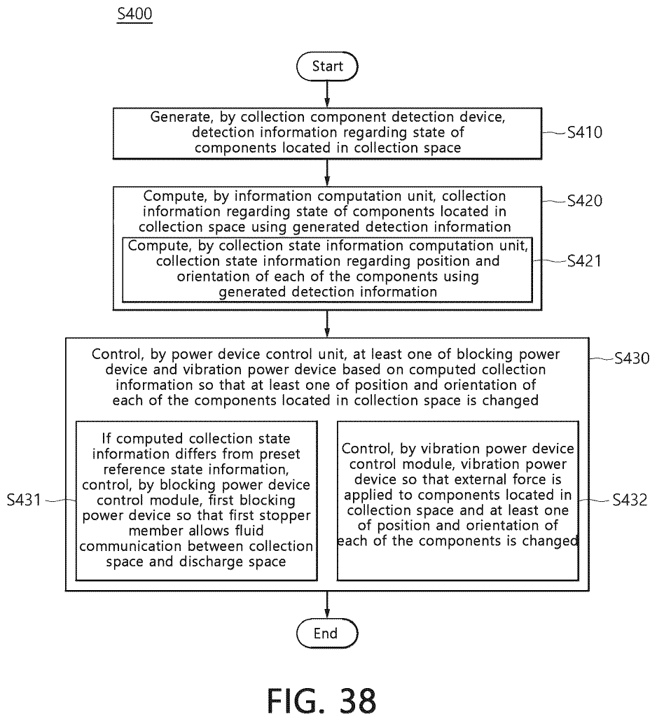

Referring to FIG. 38, a detailed flow of the step S400 of controlling the component collection unit 40 to change the state of the components transferred to the component collection unit 40 by the control unit 50 is illustrated. The step S400 corresponds to a process in which an external force is applied so that the components located in the collection space 450 can be easily identified and gripped, thereby changing at least one of the position, orientation, and arrangement state of the components.

First, the collected component detection device 490 generates detection information about the state of the components located in the collection space 450 (S410). The collection information computation module 850 of the information computation unit 800 computes collection information about the state of the components located in the collection space 450 based on the generated detection information (S420).

At this time, the collection state information computation unit 853 may compute collection state information about at least one of the position, orientation, and arrangement state of the components based on the generated detection information (S421).

Next, the power device control unit 900 controls at least one of the blocking power device 520 and the vibration power device 710 based on the computed collection state information, thereby changing at least one of the position, orientation, and arrangement state of the components located in the collection space 450 (S430).

Specifically, if the computed collection state information differs from preset reference state information, the first blocking power device control module 941 controls the blocking power device 520 so that the first stopper member 500a establishes fluid communication between the collection space 450 and the discharge space 460 (S431). In addition, the vibration power device control module 960 controls the vibration power device 710 so that an external force is applied to the components located in the collection space 450, thereby changing at least one of the position, orientation, and arrangement state of the components located in the collection space 450 (S432).

Although exemplary embodiments of the present disclosure have been described, the spirit of the present disclosure is not limited to the embodiments set forth herein. Those of ordinary skill in the art who understand the spirit of the present disclosure may easily propose other embodiments through supplement, change, removal, addition, etc. of elements within the scope of the same inventive concept, but such embodiments will also fall within the scope of the present disclosure.

| | |
|---|---|
| 1: smart feeding system | 10: component supply unit |
| 11: first component supply unit | 12: second component supply unit |
| 13: third component supply unit | 14: fourth component supply unit |
| 20: input adjusting unit | 21: first input adjusting unit |
| 22: second input adjusting unit | 23: third input adjusting unit |
| 24: fourth input adjusting unit | 30: component transfer unit |
| 31: first component transfer unit | 32: second component transfer unit |
| 40: component collection unit | 50: control unit |
| 100: supply frame | 110: first supply frame |
| 111: first supply space | 120: second supply frame |
| 121: second supply space | 130: third supply frame |
| 140: discharge frame | 141: discharge space |
| 150: supply door member | 160: supply power device |
| 170: supply component detection device | 200: component receiving member |
| 210: tray member | 211: first tray surface |
| 212: second tray surface | 213: third tray surface |
| 214: tray space | 220: adjustment frame |
| 221: adjustment support block | 222: adjustment bar |
| 223: adjustment support angle | 224: support bar |
| 230: remaining component detection device | 240: detection frame |
| 241: detection device coupling block | 242: detection device support block |
| 243: detection device support bar | 250: input power device |
| 300: transfer conveyor | 310: belt member |
| 320: transfer power device | 330: filtering member |
| 400: receiving conveyor | 400a: first receiving conveyor |
| 400b: second receiving conveyor | 410: vibration belt member |
| 420: conveyor partition | 421: outer conveyor partition |
| 422: dividing conveyor partition | 430: bumper member |
| 440: guide member | 450: collection space |
| 460: discharge space | 470: discharge slope member |
| 480: blocking partition | 490: collected component detection device |
| 500: stopper member | 500a: first stopper member |
| 500b: second stopper member | 510: blocking plate |
| 520: blocking power device | 530: blocking frame |
| 600: collection power device | 700: vibration transfer member |
| 710: vibration power device | 711: support plate |
| 712: vibration generating device | 713: protection block |
| 714: protection plate | 715: amplifying plate |
| 716: elastic member | 720: vibration frame |
| 800: information computation unit | 810: product information input module |
| 811: product specification information input unit | 812: product quantity information input unit |
| 820: component information computation module | 821: component specification information computation unit |
| 822: component quantity information computation unit | 830: supply information computation module |
| 831: supply specification information computation unit | 832: supply quantity information computation unit |
| 840: remaining information computation module | 850: collection information computation module |
| 851: collection specification information computation unit | 852: collection quantity information computation unit |
| 853: collection state information computation unit | 860: vibration information computation module |
| 870: movement information computation module | 880: discharge information computation module |
| 900: power device control unit | 910: supply power device control module |
| 920: input power device control module | 930: transfer power device control module |
| 940: blocking power device control module | 941: first blocking power device control module |
| 942: second blocking power device control module | |
| 950: collection power device control module | 960: vibration power device control module |
| B: bucket | C: closing direction |
| O: opening direction | a: downward direction |
| b: upward direction | d1: first direction |
| d2: second direction | v: vibration |

1. A smart feeding system, comprising:
a component supply unit configured to receive components from an external source; and
a component receiving unit disposed below at least a portion of the component supply unit and configured to receive the components from the component supply unit and to provide the received components to the outside,
wherein the component receiving unit comprises:
a receiving conveyor extending in a longitudinal direction and configured to support the components transferred from the component supply unit; and
a stopper member configured to divide an inner space of the receiving conveyor into a plurality of spaces along the longitudinal direction,
wherein the components transferred from the component supply unit are located in one of the plurality of spaces,
the components moved to another one of the plurality of spaces along the longitudinal direction are provided to the outside, and
the stopper member is vertically movably coupled to the receiving conveyor so that the one space and the other one space are fluidly connected or blocked.

2. The smart feeding system of claim 1,
wherein the receiving conveyor comprises:
a vibration belt member configured to be movable to one side and the other side in the longitudinal direction, to support the components, and to surround the inner space from below; and
a dividing conveyor partition extending in the longitudinal direction and configured to divide the inner space into a plurality of spaces in a width direction of the vibration belt member.

3. The smart feeding system of claim 1,
wherein the receiving conveyor comprises:
a vibration belt member configured to be movable to one side and the other side in the longitudinal direction, to support the components, and to surround the inner space from below; and
a conveyor partition extending in the longitudinal direction and surrounding the inner space in a width direction,
wherein the stopper member is coupled to the conveyor partition, and comprises:
a blocking frame fixedly coupled to the conveyor partition and extending in the width direction;
a blocking power device coupled to the blocking frame; and
a blocking plate coupled to the blocking power device and configured to divide the inner space into the plurality of spaces,
wherein the blocking power device is configured to support the blocking plate to be vertically movable.

4. The smart feeding system of claim 3,
wherein the stopper member is provided in plurality, and the plurality of stopper members are spaced apart from each other in the longitudinal direction,
and the plurality of stopper members are configured to be vertically movable independently of each other.

5. The smart feeding system of claim 1,
further comprising a vibration transmission member that is positioned adjacent to the other one space and configured to apply vibration to the components located in the other one space to rearrange the components,
wherein the receiving conveyor comprises:
a vibration belt member configured to be movable to one side and the other side in the longitudinal direction, to support the components, and to surround the inner space from below,
wherein the vibration transfer member comprises:
a vibration generating device configured to apply the vibration to the vibration belt member;
a support plate disposed opposite to the vibration belt member and configured to support the vibration generating device;
and an amplifying plate disposed to face the support plate with the vibration generating device interposed therebetween, the amplifying plate being in contact with the vibration belt member and configured to transmit the vibration to the vibration belt member.

6. The smart feeding system of claim 1,
further comprising an input adjusting unit that is positioned, in a height direction, between the component supply unit and the component receiving unit and is configured to receive the components from the component supply unit and deliver the components to the component receiving unit,
wherein the input adjusting unit comprises:
a tray member positioned below the component supply unit and configured to receive the components from the component supply unit; and
an input power device coupled to the tray member and configured to movably support a portion of the tray member.

7. A control method of a smart feeding system, comprising:
(a) computing, by a control unit, component information regarding components to be supplied;
(b) controlling, by the control unit, a component supply unit so that the components are supplied to a component receiving unit based on the computed component information;
(c) controlling, by the control unit, at least one of the component supply unit, an input adjusting unit, a component transfer unit, and the component receiving unit based on the quantity of the supplied components; and
(d) controlling, by the control unit, the component collection unit to change a state of the components delivered to the component collection unit.

8. The control method of claim 7,
wherein the step (a) comprises:
(a1) receiving, by an information computation unit, product information regarding a product to be manufactured using the components; and
(a2) computing, by the information computation unit, the component information using the received product information,
wherein the product information includes product specification information regarding specifications of the product and product quantity information regarding a quantity of the product.

9. The control method of claim 7,
wherein the step (b) comprises:
(b1) computing, by the information computation unit, supply information using the computed component information; and
(b2) controlling, by a power device control unit, a supply power device based on the computed supply information.

10. The control method of claim 9,
wherein the component supply unit is provided in plurality, and the plurality of component supply units are each configured to supply the components having different specifications,
wherein the step (b1) comprises:
(b11) computing, by a supply information computation module, supply specification information regarding specifications of the components to be supplied using the computed component specification information; and
(b12) computing, by the supply information computation module, supply quantity information regarding a quantity of the components to be supplied using the computed component quantity information,
wherein the component information includes the component specification information and the component quantity information,
and the supply information includes the supply specification information and the supply quantity information, and
wherein the step (b2) comprises:
(b21) selecting, by a supply power device control module, at least one of the plurality of component supply units based on the computed supply specification information;
(b22) computing, by the supply power device control module, control information for controlling a supply power device provided in the at least one component supply unit using the computed supply quantity information; and
(b23) controlling, by the supply power device control module, the supply power device provided in the at least one component supply unit based on the computed control information.

11. The control method of claim 9,
wherein the step (b) comprises, prior to the step (b1):
(b0) computing, by the information computation unit, discharge information using detection information regarding specifications of the components collected in the component collection unit,
wherein the step (b0) comprises:
(b01) generating, by a collected component detection device, detection information regarding the components located in a collection space;
(b02) computing, by a collection information computation module, collection specification information regarding the specifications of the components located in the collection space using the generated detection information;
(b03) computing, by a discharge information computation module, discharge information using the computed collection specification information and the component information;
(b04) controlling, by a blocking power device control module, a blocking power device based on the computed discharge information; and
(b05) controlling, by a collection power device control module, a collection power device based on the computed discharge information.

12. The control method of claim 7,
wherein the step (c) comprises:
(c1) generating, by a remaining component detection device, detection information regarding a quantity of the components accommodated in a tray member;
(c2) computing, by an information computation unit, remaining information regarding the quantity of the components remaining in the tray member using the generated detection information; and
(c3) controlling, by a power device control unit, at least one of a supply power device, an input power device, and a transfer power device based on the computed remaining information.

13. The control method of claim 12,
wherein the step (c3) comprises:
(c31) controlling, by a supply power device control module, the supply power device based on the computed remaining information;
(c32) controlling, by an input power device control module, the input power device based on the computed remaining information; and
(c33) controlling, by a transfer power device control module, the transfer power device based on the computed remaining information,
wherein the step (c31) comprises:
(c311) if the computed remaining information is equal to or greater than a preset reference remaining information, controlling, by the supply power device control module, the supply power device to stop; and
(c312) if the computed remaining information is less than the reference remaining information, controlling, by the supply power device control module, the supply power device to operate,
wherein the step (c32) comprises:
(c321) if the computed remaining information is less than a preset reference remaining information, controlling, by the input power device control module, the input power device so that the components accommodated in the tray member are not delivered to the component transfer unit; and
(c322) if the computed remaining information is equal to or greater than the reference remaining information, controlling, by the input power device control module, the input power device so that the components accommodated in the tray member are delivered to the component transfer unit,
wherein the step (c33) comprises:
(c331) if the computed remaining information is equal to or greater than a preset reference remaining information, controlling, by the transfer power device control module, the transfer power device so that the components are delivered to the component collection unit; and
(c332) if the computed remaining information is less than the reference remaining information, controlling, by the transfer power device control module, the transfer power device to stop.

14. The control method of claim 12,
wherein the step (c) comprises:
(c4) generating, by a collected component detection device, detection information regarding a quantity of components accommodated in a collection space;
(c5) computing, by the information computation unit, collection information regarding the components accommodated in the collection space using the generated detection information; and
(c6) controlling, by the power device control unit, at least one of a blocking power device and a collection power device based on the computed collection information,
wherein the step (c6) comprises:
(c61) if the computed collection quantity information is equal to or greater than a preset reference quantity information, controlling, by the power device control unit, at least one of the blocking power device and the collection power device so that the components located in a discharge space are not moved to the collection space; and
(c62) if the computed collection quantity information is less than the reference quantity information, controlling, by the power device control unit, at least one of the blocking power device and the collection power device so that the components located in the discharge space are moved to the collection space,
wherein the collection quantity information is information regarding a quantity of components accommodated in the collection space.

15. The control method of claim 7,
wherein the step (d) comprises:
(d1) generating, by a collected component detection device, detection information regarding a state of each of the components positioned in a collection space;
(d2) computing, by an information computation unit, collection information regarding the state of each of the components positioned in the collection space based on the generated detection information; and
(d3) controlling, by a power device control unit, at least one of a blocking power device and a vibration power device based on the computed collection information, thereby changing at least one of a position and an orientation of each of the components positioned in the collection space,
wherein the step (d2) comprises:
(d21) computing, by a collection state information computation unit, collection state information regarding the position and orientation of each of the components based on the generated detection information, and
wherein the step (d3) comprises:
(d31) if the computed collection state information is different from a preset reference state information, controlling, by a first blocking power device control module, a first blocking power device such that a first stopper member allows fluid communication between the collection space and the discharge space; and
(d32) controlling, by a vibration power device control module, a vibration power device such that an external force is applied to each of the components positioned in the collection space, thereby changing at least one of the position and the orientation of each of the components positioned in the collection space.
